(19) United States
(12) Patent Application Publication
(10) Pub. No.: US 2024/0421959 A1
(43) Pub. Date: Dec. 19, 2024

(54) WIRELESS COMMUNICATION SYSTEMS AND METHODS FOR MULTIPLE ACCESS

(71) Applicant: HUAWEI TECHNOLOGIES CO., LTD., Shenzhen (CN)

(72) Inventors: SANJEEWA HERATH, Ottawa (CA); Lei Wang, Shenzhen (CN)

(21) Appl. No.: 18/814,047

(22) Filed: Aug. 23, 2024

Related U.S. Application Data
(63) Continuation of application No. PCT/CN2022/077684, filed on Feb. 24, 2022.

(51) Int. Cl. H04L 5/00; H04L 27/26

(52) U.S. Cl. CPC H04L 5/0053; H04L 27/2602

(57) ABSTRACT

In a wireless communications having a base station in communication with a plurality of user equipments (UEs), the UEs are classified into a plurality of UE groups based on the communication conditions thereof. Each UE is assigned with a device-based signature for the UE and a group-based signature for a group having the UE as a member thereof. Then, a wireless signal is generated based on the first and second signatures and transmitted between the base station and the UE.

### CROSS-REFERENCE TO RELATED APPLICATION

This application is a continuation of Patent Cooperation Treaty Application Serial No. PCT/CN2022/077684, filed Feb. 24, 2022, the content of which is incorporated herein by reference in its entirety.

### TECHNICAL FIELD

The present disclosure relates generally to wireless communication systems and methods for multiple access, and in particular to wireless communication systems and methods for non-orthogonal multiple access using device-based and/or group-based signatures, group of beams-based signatures where the group including a single beam.

### BACKGROUND

Multiple access has been widely used in wireless communication systems, wherein a plurality of user equipments (UEs) share a physical resource such as a frequency-time resource for communication. Recently, non-orthogonal multiple access (NoMA) technologies have been used for efficiently sharing the physical resource for wireless communication wherein a signal transmitted to or from a transmitter (such as a UE or a base-station/gNodeB (gNB)) may be differentiated from signals transmitted to or from other transmitters by using a so-called MA signature.

### SUMMARY

According to one aspect of this disclosure, there is provided a method comprising: obtaining a first signature for a group comprising a user equipment (UE); obtaining a second signature for the UE; generating a wireless signal based on the first and second signatures; and transmitting the wireless signal via a physical resource from or to the UE.

In some embodiments, said generating the wireless signal based on the first and second signatures comprises: generating a bit sequence; modifying the bit sequence based on one of the first and second signatures; generating a symbol sequence using the modified bit sequence; modifying the symbol sequence based on the other of the first and second signatures; and generating the wireless signal based on the modified symbol sequence.

In some embodiments, said generating the wireless signal based on the first and second signatures comprises: generating a bit sequence; modifying the bit sequence based on the first and second signatures; generating a symbol sequence using the modified bit sequence; and generating the wireless signal based on the symbol sequence.

In some embodiments, said generating the wireless signal based on the first and second signatures comprises: generating a bit sequence; generating a symbol sequence using the bit sequence; modifying the symbol sequence based on the first and second signatures; and generating the wireless signal based on the modified symbol sequence.

In some embodiments, the second signature comprises F elements s(0), s(1), . . . , s(F−1), where F>1 is an integer; the first signature comprises F elements c(0), c(1), . . . , c(F−1); and said generating the wireless signal based on the first and second signatures comprises: calculating a third signature as c(0)s(0), c(1)s(1), . . . , c(F−1)s(F−1); and generating a wireless signal based on the third signature.

In some embodiments, said obtaining the second signature comprises: obtaining at least a first index of the second signature indicating the second signature in a second signature pool comprising a plurality of second signatures; and obtaining the second signature from the second signature pool using the at least first index of the second signature.

In some embodiments, said obtaining the at least first index of the second signature comprises: randomly generating the at least first index of the second signature.

In some embodiments, said obtaining the at least first index of the second signature comprises: receiving the at least first index of the second signature.

In some embodiments, the at least first index of the second signature comprises the first index of the second signature and a second index of the second signature indicating the second signature pool in a plurality of second signature pools; and said obtaining the second signature from the second signature pool using the at least first index of the second signature comprises: obtaining the second signature pool from the plurality of second signature pools using the second index of the second signature, and obtaining the second signature from the second signature pool using the first index of the second signature.

In some embodiments, said obtaining the first signature comprises: obtaining at least a first index of the first signature indicating the first signature in the first signature pool comprising a plurality of first signatures; and obtaining the first signature from the first signature pool using the at least first index of the first signature.

In some embodiments, said at least first index of the first signature comprises the first index of the first signature and a second index of the first signature indicating the first signature pool in a plurality of first signature pools; and wherein said obtaining the first signature from the first signature pool using the at least first index of the first signature comprises: obtaining the first signature pool from the plurality of first signature pools using the second index of the first signature, and obtaining the first signature from the first signature pool using the first index of the first signature pool.

In some embodiments, the wireless signal is a data-bearing signal or a reference signal.

In some embodiments, the group comprises one or more UEs communicating with a base station using one or more signal beams.

In some embodiments, the method further comprises: obtaining communication conditions of the physical resource; and classifying a plurality of UEs using the physical resource for communication into one or more UE groups based on the obtained communication conditions, the plurality of UEs comprising the UE; said transmitting the wireless signal via the physical resource comprises: transmitting the wireless signal to the UE via the physical resource; and said obtaining the first signature comprises: determining the first signature based on the UE group of the UE.

In some embodiments, the communication conditions comprise at least one of spatial diversities, levels of inter-beam interference, channel-correlation levels, traffic levels, transport block sizes (TBS), and activity levels.

According to one aspect of this disclosure, there is provided a method comprising: communicating between a first device and a second device for determining a first signature for a group comprising the second device and a second signature for the second device; generating, by one of the first and second devices, a wireless signal based on the first and second signatures; and transmitting, from the one of the first and second devices, the wireless signal to the other of the first and second devices.

In some embodiments, said communicating between the first device and the second device comprises: obtaining communication conditions of a physical resource for transmitting the wireless signal; classifying a plurality of second devices using the physical resource for communication into one or more groups based on the obtained communication conditions, the plurality of second devices comprising the second device; obtaining, based on the group of the second device, at least a first index of a first signature indicating the first signature in a first signature pool comprising a plurality of first signatures; and transmitting, indicating, or signaling the at least first index of the first signature to the second device for the second device to obtain the first signature from the first signature pool using the at least first index of the first signature.

In some embodiments, said at least first index of the first signature comprises the first index of the first signature and a second index of the first signature indicating the first signature pool in a plurality of first signature pools.

In some embodiments, the method further comprises: obtaining at least a first index of a second signature indicating a second signature in a second signature pool comprising a plurality of second signatures; and transmitting, indicating, or signaling the at least first index of the second signature to the second device for the second device to obtain the second signature from the second signature pool using the at least first index of the second signature, generate the wireless signal based on the first and second signatures, and transmit the wireless signal.

In some embodiments, said at least first index of the second signature comprises the first index of the second signature and a second index of the second signature indicating the second signature pool in a plurality of second signature pools.

According to one aspect of this disclosure, there is provided an apparatus for executing instructions to perform actions comprising: obtaining a first signature for a group comprising a user equipment (UE); obtaining a second signature for the UE; generating a wireless signal based on the first and second signatures; and transmitting the wireless signal via a physical resource from or to the UE.

According to one aspect of this disclosure, there is provided an apparatus for executing instructions to perform actions comprising: communicating between a first device and a second device for determining a first signature for a group comprising the second device and a second signature for the second device; generating, by one of the first and second devices, a wireless signal based on the first and second signatures; and transmitting, from the one of the first and second devices, the wireless signal to the other of the first and second devices.

According to one aspect of this disclosure, there is provided a non-transitory computer-readable storage medium comprising computer-executable instructions, wherein the instructions, when executed, cause a processing structure to perform actions comprising: obtaining a first signature for a group comprising a user equipment (UE); obtaining a second signature for the UE; generating a wireless signal based on the first and second signatures; and transmitting the wireless signal via a physical resource from or to the UE.

According to one aspect of this disclosure, there is provided a non-transitory computer-readable storage medium comprising computer-executable instructions, wherein the instructions, when executed, cause a processing structure to perform actions comprising: communicating between a first device and a second device for determining a first signature for a group comprising the second device and a second signature for the second device; generating, by one of the first and second devices, a wireless signal based on the first and second signatures; and transmitting, from the one of the first and second devices, the wireless signal to the other of the first and second devices.

The above-described method, apparatus, and non-transitory computer-readable storage medium uses the modified MA signatures generated based on UE grouping for mitigating inter-beam interference and exploiting the remaining inter-beam channel diversity, and for mitigating the intra-beam multi-user interference and exploiting the remaining intra-beam channel diversity.

### BRIEF DESCRIPTION OF THE DRAWINGS

FIG. 1 is a simplified schematic diagram showing a communication system, according to some embodiments of this disclosure;

FIG. 2 is a simplified schematic diagram of a base station of the communication network of the communication system shown in FIG. 1;

FIG. 3 is a simplified schematic diagram of a user equipment (UE) of the communication system shown in FIG. 1;

FIG. 4 is a simplified schematic diagram illustrating various states of a UE shown in FIG. 3;

FIG. 5A is a simplified schematic diagram showing an example of a base station forming a plurality of beams for transmitting wireless signals to a plurality of UEs;

FIG. 5B is a simplified schematic diagram showing an example of a base station using beam sweeping to cover a large geographic area and support a large number of UEs;

FIG. 6A is a simplified schematic diagram showing a plurality of signal beams and the synchronization signal blocks (SSBs) associated therewith;

FIG. 6B is a simplified frequency-time diagram showing the transmission of the SSBs;

FIG. 7 is a simplified frequency-time diagram showing a physical resource used by a plurality of UEs in orthogonal multiple access (OMA) or non-orthogonal multiple access (NoMA) communications;

FIGS. 8A to 8D show examples of the grouping of four beams based on the beam-correlation levels thereof, wherein

FIG. 8A shows a first configuration wherein the four beams are highly correlated and are classified into one group,

FIG. 8B shows a second configuration wherein the four beams are classified into a first group having three highly correlated beams and a second group having one beam, and

FIG. 8C shows a third configuration wherein the four beams are classified into a first group having two highly correlated beams and a second group having the other two highly correlated beams;

FIG. 8D shows a fourth configuration wherein the four beams are classified into four groups each having one beam;

FIG. 9 is a flowchart showing a process for generating a combined signature using a group-based signature and a device-based signature for a UE;

FIG. 10 is a simplified block diagram showing a process for generating a NoMA signal;

FIG. 11 is a flowchart showing a process for generating a group-based reference signal for a UE;

FIGS. 12A and 12B show examples of demodulation reference signals (DM-RS);

FIG. 13 shows an example of downlink transmission between a base station and a UE;

FIG. 14 is a signaling diagram showing an uplink data transmission between a UE and a base station using a NoMA signal generated based on a device-based signature and a group-based signature, according to some embodiments of this disclosure;

FIG. 15 is a signaling diagram showing an uplink data transmission between a UE and a base station using a NoMA signal generated based on a device-based signature and a group-based signature, according to some other embodiments of this disclosure;

FIG. 16 is a signaling diagram showing an uplink group-based reference signal from a UE to a base station wherein the group-based reference signal combines a device-based reference signal and a group-based signature, according to some embodiments of this disclosure;

FIG. 17 is a signaling diagram showing a group-based reference signal from a UE to a base station wherein the group-based reference signal combines a device-based reference signal and a group-based signature, according to some other embodiments of this disclosure.

### DETAILED DESCRIPTION

Embodiments disclosed herein relate to wireless communication systems and methods for non-orthogonal multiple access (NoMA) using device-based and group-based signatures. The wireless communication system comprises at least one radio-access network (RAN) having at least one base station for communication with a plurality of user equipments (UEs). The UEs may be in communication with the base station via one or more signal beams.

The plurality of UEs are classified into one or more groups based on the communication conditions thereof such as beam channel correlation levels, UE traffic, transport block sizes (TBS), RRC state, and/or the like. Each UE group is assigned with a group-based signature selected from a group-based signature pool, and each UE is also assigned with a device-based signature selected from a device-based signature pool. The selected group-based and device-based signatures for each UE are used for generating wireless signals (such as NoMA wireless signals or other wireless signals) for transmitting between the UE and a base station or between UEs. The group-based signature is selected, derived, or assigned based on the UE grouping for mitigating the inter-beam interference and exploiting the remaining inter-beam channel diversity. The device-based signature is selected, derived, or assigned based on the number of UEs active in a given beam for mitigating the intra-beam multi-user interference and exploiting the remaining intra-beam channel diversity.

In some embodiments, the correspondence between the selected group-based and device-based signatures and the UE group that the UE is associated therewith may be explicitly signaled to the UE prior to the UE transitioning to RRC inactive state or while the UE is in RRC inactive state. In some other embodiments, such correspondence may be implicitly obtained or derived by the UE from one or more of downlink reference signals prior to transitioning to RRC inactive state or while the UE is in RRC inactive state. The correspondence between the selected group-based and device-based signatures may be defined for one or more RRC states. For example, grouping is defined/signaled for both RRC inactive and connected state. In another scenario, grouping is defined/signaled only for RRC inactive state. In some scenario, group of UEs are the UEs in RRC inactive state UEs (excluding RRC connected and RRC idle state UEs) and group based signature is obtained based on the group (that is, the RRC inactive state).

In various embodiments, the group-based signature may be a cover code, a spreading sequence, a scrambling sequence, bit interleaving, symbol interleaving or alike.

In some embodiments, the device-based signature may be a conventional multiple-access (MA signature). In some other embodiments, the device-based signature may be a cover code, a spreading sequence, a scrambling sequence, bit interleaving, symbol interleaving, or the like.

The group-based and device-based signatures may be applied to the wireless signals in any suitable manner. For example, in some embodiments, the device-based signature may be used to modify an information sequence (which may be, for example, in the form of a bit sequence or a symbol sequence, and is used for generating a wireless signal) first and then the group-based signature may be applied for adjusting the phase (wherein the information sequence may be a bit or symbol sequence) of the information sequence modified by the device-based signature, the amplitude thereof (if the information sequence is a symbol sequence), or both phase and amplitude thereof. As such, the device-based signature is embedded into the signal and the group-based signature may change the signal phase, amplitude, or both. The group-based signature may adjust the power of the signal wherein power adjustment may be achieved by amplitude change. The wireless signal is then generated from the information sequence modified by the device-based and group-based signatures.

In various embodiments, the modification of the information sequence by the device-based signature and/or the group-based signature may be performed at the bit level (wherein the information sequence is considered a bit sequence, and the device-based signature and/or the group-based signature modifies the information sequence using bit-operation) and/or at the symbol level (wherein the information sequence is considered as or otherwise mapped to a symbol sequence, and the device-based signature and/or the group-based signature modifies the information sequence using symbol-operation).

In some embodiments, the device-based signature and/or the group-based signature may be separately applied to the information sequence.

In some other embodiments, the group-based and device-based signatures may be combined into a single signature (denoted a “combined” signature hereinafter), and then the combined signature is applied to the information sequence.

As those skilled in the art will appreciate, the device-based signature is usually used for mitigating the interference caused by multiple transmissions collisions such as intra-beam multi-user interference and for exploiting channel diversity, and may be considered an identifier assigned to each UE for uniquely identifying the UE. The group-based signature is used for mitigating the inter-beam interference and exploiting the inter-beam channel diversity and may be considered an identifier assigned to the UEs of each UE group for uniquely identifying the UE group.

In some embodiments, the group that a UE belongs thereto or associated therewith is signaled from the network side (such as a base-station) to the UE, or is otherwise known or determined by the UE such as using the beam or the group of beams that the UE belongs thereto. For example, in some embodiments, the network side may determine/signal a set of N₁ beams to the UE side and the UEs whose coverage of that N₁ beams may be classified into a UE group. In another example, the network side may transmit/broadcast synchronization signal blocks (SSBs) in each beam and UEs associated with a specific SSB belongs to a UE group. In yet another example, the network side may explicitly signal to UEs of a UE group so as to let each of these UEs to know the UE group it belongs thereto. In some other embodiments, a UE may obtain its association with a group indirectly (for example, the network side signals a set of beams/SSB indices to UE and a mapping or an association or correspondence of group-based signature to beam/SSB indices). With the knowledge of the device-based signature, a UE generates a first sequence of symbols using the device-based signature (therefore, the first sequence symbols embeds the device-based signature) and the UE further processes the first sequence of symbols using the group-based signature to obtain a second sequence of symbols. The processing on the first symbol sequence involves application of the group-based signature on the first symbol sequence. Therefore, the second sequence symbol may be considered to embed both the device-based and group-based signatures. The receiver side may decode and demodulate the received signal using the device-based signature, the group-based signature, or both. Therefore, a combination of device-based signature and the group-based signature may be considered as a combined MA signature.

### A. System Structure

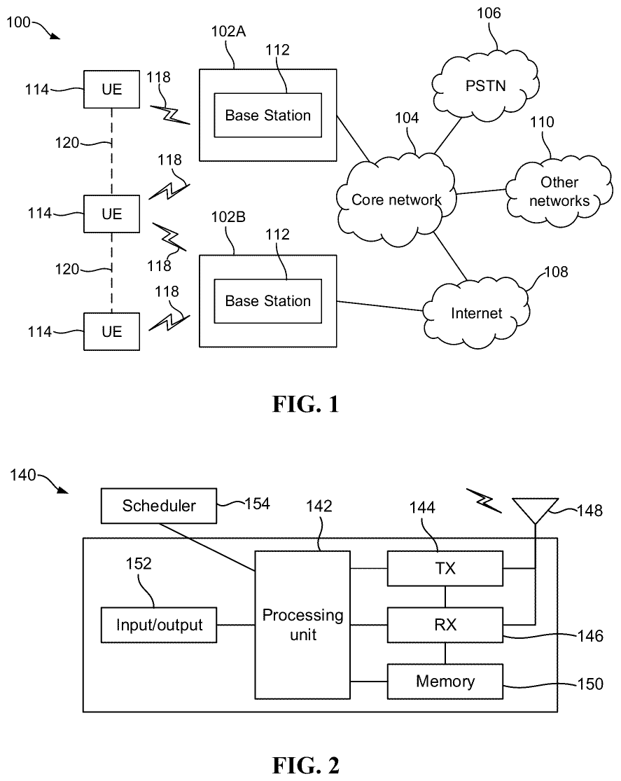

Turning now the FIG. 1, a communication system according to some embodiments of this disclosure is shown and is generally identified using reference numeral 100. The communication system 100 enables a plurality of UEs 114 to communicate data and other content, and may provide content (such as voice, data, video, text, and/or the like) via broadcast, multicast, unicast, UE-to-UE, and/or the like. The communication system 100 enables so-called multiple access of a plurality of UEs 114 by efficiently sharing communication resources such as time, frequency, and/or space resources among the UEs 114.

In these embodiments, the communication system 100 comprises two RANs 102A and 102B (each generally referred to as a RAN 102 and collectively referred to as RANs 102) connecting to a core network 104 directly or indirectly (for example, via the internet 108). The core network 104 may be in communication with one or more communication networks such as a public switched telephone network (PSTN) 106, the internet 108, and/or other networks 110. PSTN 106 may include circuit switched telephone networks for providing plain old telephone service (POTS). Internet 108 may include a network of computers and subnets (intranets) or both, and incorporate protocols, such as Internet Protocol (IP), Transmission Control Protocol (TCP), User Datagram Protocol (UDP), and/or the like.

The RANs 102A and 102B communicate with the UEs 114 to enable the UEs 114 to operate and/or communicate in the communication system 100, or more specifically, to communicate with the core network 104, the PSTN 106, the internet 108, other networks 110, or any combination thereof. The RANs 102 and/or the core network 104 may be in direct or indirect communication with one or more other RANs (not shown), which may or may not be directly served by the core network 104, and may or may not employ the same radio access technology as RAN 102A, 102B, or both. The core network 104 may also serve as a gateway access between (i) the RANs 102 or UEs 114 or both, and (ii) other networks (such as the PSTN 106, the internet 108, and the other networks 110).

Each RAN 102 comprises one or more base stations 112 and is configured to wirelessly connect with one or more UEs 114 to enable access to any other base stations 112, the core network 104, the PSTN 106, the internet 108, and/or the other networks 110. Herein, the base stations 112 and the UEs 114 may be considered as different types of network nodes (or simply “nodes”) of the communication system 100. A base station 112 (otherwise referred to as a radio access node (RAN node) forms part of the RAN 102, which may include other base stations 112, base station controllers (BSCs), radio network controllers (RNCs), relay nodes, elements, and/or devices. A base station 112 may comprise or may be a device in any suitable form such as a base transceiver station (BTS), a Node-B (NodeB), an evolved NodeB (eNodeB), a Home eNodeB, a gNodeB or gNB (next generation NodeB, sometimes called a “gigabit” NodeB), a transmission point (TP), a transmit/receive point (TRP), a site controller, an access point (AP), a wireless router, or the like. A base station 112 may otherwise be referred to herein as a RAN node. Moreover, a base station 112 may be a single element, as shown in FIG. 1, or comprise a plurality of elements distributed in a corresponding RAN 102. Each base station 112 transmits and/or receives wireless signals within a particular geographic region or area, sometimes referred to as a “cell” or “coverage area”. A cell may be further divided into cell sectors, and a base station 112 may, for example, employ a plurality of transmitters, receivers, and/or transceivers to provide service to multiple sectors. In some embodiments, there may be established pico or femto cells where the radio access technology supports such. In some embodiments, a plurality of transceivers may be used for each cell, for example using multiple-input multiple-output (MIMO) technology. The number of RANs 102 shown in FIG. 1 is exemplary only. Any number of RANs 102 may be contemplated when devising the communication system 100.

FIG. 2 is a simplified schematic diagram of a base station 112. As shown, the base station 112 comprises at least one processing unit 142, at least one transmitter 144, at least one receiver 146 (collectively referred to as a transceiver), one or more antennas 148, at least one memory 150, and one or more input/output components or interfaces 152. A scheduler 154 may be coupled to the processing unit 142. The scheduler 154 may be included within or operated separately from the base station 112.

The processing unit 142 is configured for performing various processing operations such as signal coding, data processing, power control, input/output processing, or any other suitable functionalities. The processing unit 142 may comprise a microprocessor, a microcontroller, a digital signal processor, a FPGA, an ASIC, and/or the like. In some embodiments, the processing unit 142 may execute computer-executable instructions or code stored in the memory 150 to perform various the procedures (otherwise referred to as methods) described below.

Each transmitter 144 may comprise any suitable structure for generating signals, such as control signals as described in detail below, for wireless transmission to one or more UEs 114 or other devices. Each receiver 146 may comprise any suitable structure for processing signals received wirelessly from one or more UEs 114 or other devices. Although shown as separate components, at least one transmitter 144 and at least one receiver 146 may be integrated and implemented as a transceiver. Each antenna 148 may comprise any suitable structure for transmitting and/or receiving wireless signals. Although a common antenna 148 is shown in FIG. 2 as being coupled to both the transmitter 144 and the receiver 146, one or more antennas 148 may be coupled to the transmitter 144, and one or more separate antennas 148 may be coupled to the receiver 146.

Each memory 150 may comprise any suitable volatile and/or non-volatile storage such as RAM, ROM, hard disk, optical disc, SIM card, solid-state memory, memory stick, SD memory card, and/or the like. The memory 150 may be used for storing instructions executable by the processing unit 142 and data used, generated, or collected by the processing unit 142. For example, the memory 150 may store instructions of software, software systems, or software modules that are executable by the processing unit 142 for implementing some or all of the functionalities and/or embodiments of the procedures performed by a base station 112 described herein.

Each input/output component 152 enables interaction with a user or other devices in the communication system 100. Each input/output device 152 may comprise any suitable structure for providing information to or receiving information from a user and may be, for example, a speaker, a microphone, a keypad, a keyboard, a display, a touch screen, a network communication interface, and/or the like.

Referring back to FIG. 1, the base stations 112 of the RANs 102 may communicate with the UEs 114 via Uu links 118 which may be any suitable wireless communication links such as radio frequency (RF) links, microwave links, infrared (IR) links, and/or the like. The UEs 114 may communicate with the base stations 112 via Uu links 118 using any suitable channel access methods such as time division multiple access (TDMA), frequency division multiple access (FDMA), orthogonal FDMA (OFDMA), single-carrier FDMA (SC-FDMA), code division multiple access (CDMA), wideband CDMA (WCDMA), and/or the like.

The Uu links 118 may use any suitable radio access technologies such as universal mobile telecommunication system (UMTS), high speed packet access (HSPA), HSPA+(optionally including high speed downlink packet access (HSDPA), high-speed uplink packet access (HSUPA), or both), Long-Term Evolution (LTE), LTE-A, LTE-B, IEEE 802.11, 802.15, 802.16, CDMA2000, CDMA2000 1×, CDMA2000 EV-DO, IS-2000, IS-95, IS-856, global system for mobile communications (GSM), enhanced data rates for GSM evolution (EDGE), GSM EDGE radio access network (GERAN), 5G New Radio (5G NR), standard or non-standard satellite internet access technologies, and/or the like. Herein, a communication from a RAN 102 or a base station 112 thereof to a UE 114 is denoted as a downlink (DL) communication and a communication from a UE 114 to a RAN 102 or a base station 112 thereof is denoted as an uplink (UL) communication. Accordingly, a channel used for a downlink communication is a DL channel and a channel used for an uplink communication is a UL channel.

Herein, the UEs 114 may be any suitable wireless device that may join the communication system 100 via a RAN 102 for wireless operation. In various embodiments, a UE 114 may be a wireless electronic device used by a human or user (such as a smartphone, a cellphone, a personal digital assistant (PDA), a laptop, a computer, a tablet, a smart watch, a consumer electronics device, and/or the like). A UE 114 may alternatively be a wireless sensor, an Internet-of-things (IoT) device, a robot, a shopping cart, a vehicle, a smart TV, a smart appliance, a wireless transmit/receive unit (WTRU), a mobile station, a fixed or mobile subscriber unit, a machine type communication (MTC) device, or the like. Depending on the implementation, the UE 114 may be movable autonomously or under the direct or remote control of a human, or may be positioned at a fixed position.

In some embodiments, a UE 114 may be a multimode wireless electronic device capable of operation according to multiple radio access technologies and incorporate multiple transceivers necessary to support such.

In addition, some or all of the UEs 114 comprise functionality for communicating with different wireless devices and/or wireless networks via different wireless links using different wireless technologies and/or protocols. Instead of wireless communication (or in addition thereto), the UEs 114 may communicate via wired communication channels to other devices or switches (not shown), and to the Internet 108. For example, as shown in FIG. 1, a plurality of the UEs 114 (such as UEs 114 in proximity with each other) may communicate with each other directly via suitable wired or wireless sidelinks 120. Accordingly, a wired or wireless channel of a wired or wireless sidelink 120 is denoted a sidelink channel.

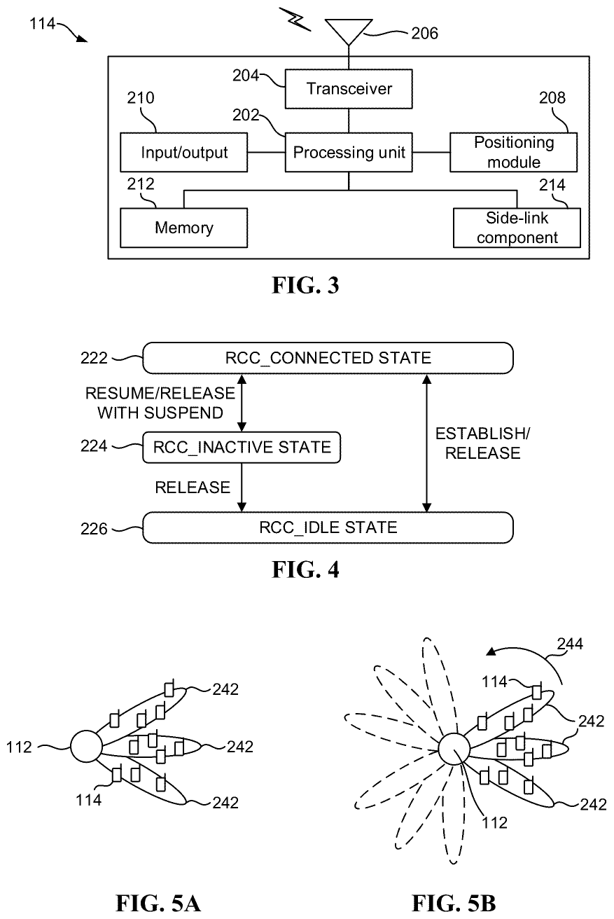

FIG. 3 is a simplified schematic diagram of a UE 114. As shown, the UE 114 comprises at least one processing unit 202, at least one transceiver 204, at least one antenna or network interface controller (NIC) 206, at least one positioning module 208, one or more input/output components 210, at least one memory 212, and at least one sidelink component 214.

The processing unit 202 is configured for performing various processing operations such as signal coding, data processing, power control, input/output processing, or any other functionalities to enable the UE 114 to access and join the communication system 100 and operate therein. The processing unit 202 may also be configured to implement some or all of the functionalities of the UE 114 described in this disclosure. The processing unit 202 may comprise a central processing unit (CPU), a microprocessor, a microcontroller, a digital signal processor, an accelerator, a graphic processing unit (GPU), a tensor processing unit (TPU), a FPGA, or an ASIC. Examples of the processing unit 202 may be an ARM® microprocessor (ARM is a registered trademark of Arm Ltd., Cambridge, UK) manufactured by a variety of manufactures such as Qualcomm of San Diego, California, USA, under the ARM® architecture, an INTEL® microprocessor (INTEL is a registered trademark of Intel Corp., Santa Clara, CA, USA), an AMD® microprocessor (AMD is a registered trademark of Advanced Micro Devices Inc., Sunnyvale, CA, USA), and the like. In some embodiments, the processing unit 202 may execute computer-executable instructions or code stored in the memory 212 to perform various processes described below.

The at least one transceiver 204 may be configured for modulating data or other content for transmission by the at least one antenna 206 to communicate with a RAN 102. The transceiver 204 is also configured for demodulating data or other content received by the at least one antenna 206. Each transceiver 204 may comprise any suitable structure for generating signals for wireless transmission and/or processing signals received wirelessly. Each antenna 206 may comprise any suitable structure for transmitting and/or receiving wireless signals. Although shown as a single functional unit, a transceiver 204 may be implemented separately as at least one transmitter and at least one receiver.

The positioning module 208 is configured for communicating with a plurality of global or regional positioning devices such as navigation satellites for determining the location of the UE 114. The navigation satellites may be satellites of a global navigation satellite system (GNSS) such as the Global Positioning System (GPS) of USA, Global'naya Navigatsionnaya Sputnikovaya Sistema (GLONASS) of Russia, the Galileo positioning system of the European Union, and/or the Beidou system of China. The navigation satellites may also be satellites of a regional navigation satellite system (RNSS) such as the Indian Regional Navigation Satellite System (IRNSS) of India, the Quasi-Zenith Satellite System (QZSS) of Japan, or the like. In some other embodiments, the positioning module 208 may be configured for communicating with a plurality of indoor positioning device for determining the location of the UE 114.

The one or more input/output components 210 is configured for interaction with a user or other devices in the communication system 100. Each input/output component 210 may comprise any suitable structure for providing information to or receiving information from a user and may be, for example, a speaker, a microphone, a keypad, a keyboard, a display, a touch screen, and/or the like.

The at least one memory 212 is configured for storing instructions executable by the processing unit 202 and data used, generated, or collected by the processing unit 202. For example, the memory 212 may store instructions of software, software systems, or software modules that are executable by the processing unit 202 for implementing some or all of the functionalities and/or embodiments of the UE 114 described herein. Each memory 212 may comprise any suitable volatile and/or non-volatile storage and retrieval components such as RAM, ROM, hard disk, optical disc, SIM card, solid-state memory modules, memory stick, SD memory card, and/or the like.

The at least one sidelink component 214 is configured for communicating with other devices such as other UEs 114 via suitable sidelinks 120. A wireless sidelink 120 may be a radio link, a WI-FI® (WI-FI is a registered trademark of Wi-Fi Alliance, Austin, TX, USA) link, a BLUETOOTH® link (BLUETOOTH is a registered trademark of Bluetooth Sig Inc., Kirkland, WA, USA), and/or the like. A wired sidelink 120 may be a connection established between two UEs 114 using a USB cable, a network cable, a parallel cable, a serial cable, and/or the like.

As shown in FIG. 4, UEs 114 may be in various states such as the radio resource control (RRC) connected state (RRC_CONNECTED state) 222, the RRC-inactive state (RRC_INACTIVE state) 224, the RRC-idle state (RRC_IDLE state) 226, or the like, and may transition therebetween.

For example, a UE 114 in the RRC-inactive state 224 may perform uplink or downlink data transmission such as mobile-originated or mobile-terminated data. In this case, while the transmission takes place, the UE 114 does not change its RRC state (that is, remaining in the same RRC state).

In other scenario, transmission takes place in uplink or downlink when the UE 114 is transitioning from one RRC state to another. For example, UE transitions from the RRC-connected state 222 to the RRC-inactive state 224 and a transmission takes place during the transition. In another example, UE transitions from the RRC-inactive state 224 to the RRC-connected state 222 and a transmission takes place during the transition.

The configuration, instructions, parameters on how such transmission may take place may have been communicated to the UE 114 prior to the communication takes place in a different RRC state or in the same RRC state the transmission take place or in RRC transitions. For example, configuration, instructions, parameters may be communicated to the UE 114 in the RRC-connected state 222. Upon receiving an instruction (the same instruction or different), the UE 114 then transitions to the RRC-inactive state 224 and transmission takes place in the RRC-inactive state 224. Such scenario, configuration, instructions, parameters are received by the UE 114 prior to transmission in a different RRC state.

In another example, configuration, instructions, parameters may be communicated to the UE 114 in the RRC-inactive state 224. Upon receiving an instruction (the same instruction or a different instruction), the UE 114 then triggers a transmission while in the RRC-inactive state 224. Such scenario, configuration, instructions, parameters are received by the UE 114 prior to transmission in the same RRC state.

In yet another example, configuration, instructions, parameters may be communicated to the UE 114 in the transition from the RRC-connected state 222 to the RRC-inactive state 224. Upon receiving an instruction (the same instruction or a different instruction), the UE 114 then triggers a transmission while in the RRC-inactive state 224. Such scenario, configuration, instructions, parameters are received by the UE 114 prior to transmission during a RRC-state transition.

The configuration, instructions, parameters for a transmission may be received by the UE 114 in the same signaling or in a different signaling to trigger the transmission. Herein, “triggering a transmission” means that the actual transmission is taking place. A UE 114 may receive signaling with instruction, configuration, parameter for transmission or the transmission may be triggered through the RRC signaling, the media access control—control element (MAC-CE) signaling, the downlink control information/uplink control information (DCI/UCI), or a combination thereof. Transmission triggering may happen in a next possible transmission opportunity following a signaling reception (therefore, transmission-trigger happens as a result of receiving the signaling). In some scenario, transmission may be triggered without instruction, for example, after receiving the configuration. Herein, “transmission” may refer to the transmission of information bits or transmission of a reference signal such as a demodulation reference signal (DM-RS), a sounding reference signal (SRS), a synchronization signal block (SSB), and/or the like. A transmission may be through the uplink or downlink, and may be UE-side originated or UE-side terminated, and/or the like.

B. Multiple Access Using Device-Based and/or Group-Based Signatures

In the following, the base stations 112 and UEs 114 are generally classified as transmitters and receivers, wherein a base station 112 may be a transmitter when it is transmitting a wireless signal or a receiver when it is receiving a wireless signal. Similarly, a UE 114 may be a transmitter when it is transmitting a wireless signal or a receiver when it is receiving a wireless signal.

In these embodiments, the base station 112 or the UE 114 or both may comprise a plurality of antennas or antenna elements 148 or 206. As known in the art, multiple antennas at the transmitter side or the receiver side or both transmitter and receiver sides may be used to provide diversity against channel fading. More specifically, the communication system 100 may exploit the fact that the channels experienced by different antennas may be at least partly uncorrelated due to for example, sufficient inter-antenna distance and/or different polarization between the antennas.

By carefully adjusting the phase and/or the amplitude of each antenna, multiple antennas at the transmitter side may be used to provide signal directivity by directing the overall power of the transmitted wireless signals along one or more directions thereby forming one or more so-called signal beams (or simply “beams”), or more generally, towards specific locations in space. In the following, a beam formed by the transmitter is also denoted a transmitter beam.

The directivity of a beam may increase the achievable transmission data rates and range/coverage due to increased power reaching the target receiver. Such directivity may also reduce the interference to other links thereby improving the overall spectrum efficiency. FIG. 5A shows an example of a base station 112 forming a plurality of beams 242 for transmitting wireless signals to a plurality of UEs 114.

Similarly, a receiver may also use multiple antennas to provide receiver-side directivity by focusing the reception towards one or more directions of target signals while suppressing interference arriving from other directions, thereby effectively forming a beam on the receiver side (denoted a “receiver beam” hereinafter).

Multi-antenna beam forming/processing may be implemented in the analog domain or digital domain or in a hybrid manner. In analog beam forming, multi-antenna processing is applied within the analog part of the transmitter chain (that is, the chain from generating a signal to transmitting the signal via the antennas), for example, after digital-to-analog (D/A) conversion. In digital beam forming, multi-antenna processing is applied within the digital part of the transmitter chain, for example, before D/A conversion. However, digital beam forming requires highly complex digital signal processing and generally one D/A converter per antenna. When a large number of antennas are used, it may be more preferable to use analog beam forming. Such analog beam forming is more common in high-frequency systems such as systems using millimeter wave (mmWave) frequency bands (for example, between 24 gigahertz (GHz) and 100 GHz).

When beam forming is used, the coverage of the wireless signal is reduced because the wireless signal is generally focused about a certain direction or a geographic location in space. As shown in FIG. 5B, beam sweeping may be used to cover a large geographic area and support a large number of UEs 114 by directing one or more beams 242 to different directions and change the directions over time (for example, rotating the beams 242 along the direction indicated by the arrow 244) to cover a large geographic area or space. Each beam 242 may service a plurality of UEs 114, and the number of UEs 114 serviced by a beam 242 may be large, for example, in applications where UEs 114 in the form of machine type communication (MTC) devices are densely deployed in a smaller area or direction.

The communication system 100 uses a physical resource for wireless communication between base stations 112 and UEs 114 wherein the physical resource may be a specific time-frequency block in a spectrum. Such resource may be beam specific or common to all beams. The network side and UE side and other devices in the system 100 may identify the beam via synchronization signal blocks (SSBs) or other methods.

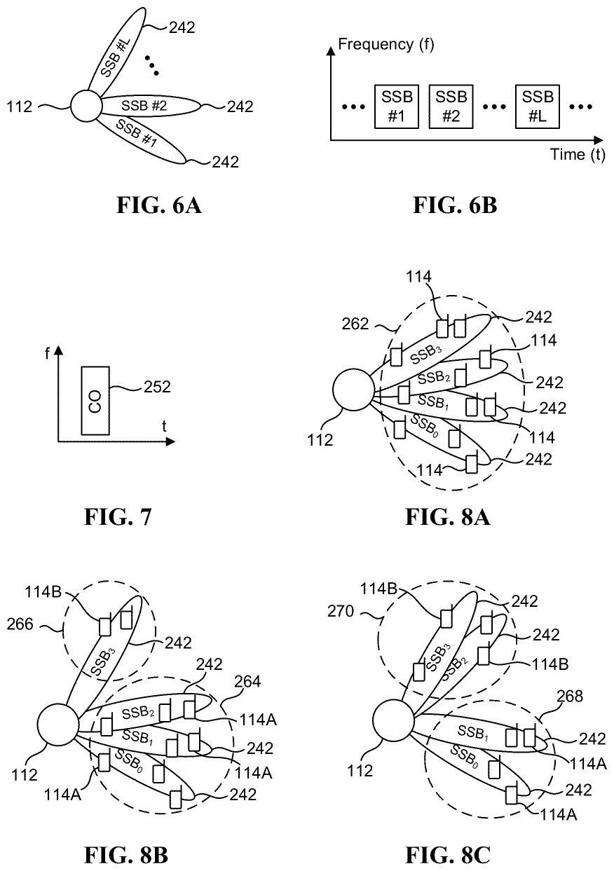

The SSB is periodically transmitted usually from the network side (such as from a base station 112) in downlink to the UEs 114 in each cell. SSB enables devices to find a cell when entering the system 100 and to find new cells when moving within the system 100. A SSB (also denoted a “SS burst”) usually comprises a primary synchronization signal (PSS) and a secondary synchronization signal (SSS), and may further comprise the Physical Broadcast Channel (PBCH). As shown in FIG. 6A, a SSB represents, corresponds to, or otherwise maps to a beam, and a synchronization signal (SS) burst of a plurality of SSBs transmitted in different beams in a time-multiplexed fashion is shown in FIG. 6B.

By applying beam-forming for the SSBs, the coverage of a SSB transmission is increased. Beam-sweeping for SSB transmission also enables receiver-side beam-sweeping for the reception of uplink random-access transmissions as well as downlink beam-forming for the random-access response. The random access and random-access response are used by the devices when performing initial access procedure for cell search and initial connection establishment (for example, device power-up), transition from the radio resource control (RRC) idle or inactive state to the RRC-connected state, beam switching, hand over, and/or the like. By using the SSB or PSS/SSS or PBCH, a beam may be uniquely identified. Alternatively, beam may be identified through signaling from network side to the device side.

As known in the art, reference signals may be transmitted in a beam and used for channel estimation, phase tracking, measuring the long term channel variation, and/or the like. For example, in 5G NR, reference signals are predefined signals occupying specific resource elements within the time-frequency grid. Non-limiting examples of reference signals include demodulation reference signals (DM-RS), Phase-tracking reference signals (PT-RS), CSI reference signals (CSI-RS), tracking reference signals (TRS), and SRS.

Wireless communications generally experience noises and interferences. When UEs 114 are densely deployed, they may be close to each other and experience similar propagation characteristics, and therefore the propagation channels of two UEs 114 may be highly correlated which may cause interferences to each other. Such interference is denoted multi-user interference and may occur in uplink (for example, from a UE 114 to a base station 112), downlink (for example, from a base station 112 to a UE 114) or sidelinks (for example, between two UEs 114). Generally, UEs 144 using a beam for communication may experience interference from other UEs using the same beam (denoted “intra-beam interference”), and more UEs 114 using the same beam may cause more severe intra-beam interference to each other. Moreover, beams adjacent to each other may have high correlations and thus UEs 114 using such beams may experience high multi-user interference (also denoted “inter-beam interference”) from neighboring beams. On the other hand, beams spaced further away from each other may have lower correlations and thus UEs 114 using such beams may experience low multi-user interference.

Various multiple access technologies may be used to combat the interferences and noises. For example, orthogonal multiple access technologies such as time division multiple access (TDMA), frequency division multiple access (FDMA), and code division multiple access (CDMA) using orthogonal codes, and/or the like use orthogonal signals in different domains (such as the time domain, frequency domain, code domain, and/or the like) wherein the wireless signals are transmitted in separated resource blocks (such as in separated time, frequency, code, and/or the like) to combat the interferences and noises.

In these embodiments, the communication system 100 uses NoMA methods wherein the wireless signals are transmitted in same resource blocks and are distinguished by using different device-based and/or group-based signatures which may uniquely identify or separate a signal from other signals.

Non-limiting examples of NoMA technologies include sparse code multiple access (SCMA), interleave-grid multiple access (IGMA), multi-user shared access (MUSA), low code rate spreading (LCRS), frequency domain spreading, non-orthogonal coded multiple access (NCMA), pattern division multiple access (PDMA), resource spread multiple access (RSMA), low density spreading with signature vector extension (LDS-SVE), low code rate and signature based shared access (LSSA), non-orthogonal coded access (NOCA), interleave division multiple access (IDMA), repetition division multiple access (RDMA), or group orthogonal coded access (GOCA).

In some embodiments of this disclosure, the communication system 100, or more specifically the base station 112 thereof, classifies UEs 114 into one or more beam groups (which are also UE groups) and determines a group-based signature for the UEs of each beam group based on the UE grouping. The communication system 100 or the base station 112 thereof also determines a device-based signature for each UE 114. Then, the communication system 100 or the base station 112 thereof embeds or otherwise applies each pair of the determined group-based and device-based signatures to the wireless signals of the corresponding UE (that is, the wireless signals transmitted to or from the corresponding UE 114) for exploiting inter-beam and intra-beam channel diversities to improve data communication under varying intra-beam and inter-beam interference levels, and are suitable for use in various multiple-access applications such as mmWave NoMA (also denoted “3D-MA”).

Herein, a group-based signature is generally used for mitigating the inter-beam interference and exploiting the remaining inter-beam channel diversity and may be considered an identifier assigned to or otherwise associated with the UEs 114 in a beam group for uniquely identifying that a received wireless signal is associated with a UE of the beam group identified by the group-based signature (for example, originated from a UE of the beam group (if the wireless signal is received by the base station 112) or transmitted to a UE of the beam group (if wireless signal is received by the UE)).

In effect, a group-based signature may be described as a signature assigned to or associated with or mapped to or corresponds to a group of transmitters (wherein, each transmitter may, for example, use a beam for communicating with one or more UEs). In a special case, the group size may be one (1), that is, a single transmitter. A signature may be considered a unique identifier assigned to a transmission. Subsequently the signature is embedded or applied to the wireless signal transmitted in the transmission. In other words, signature is being used in the signal generation in the transmission blocks. In a typical system, signatures are listed or tabulated, and then the assignment, correspondence, mapping, or association of the signatures is provided to the transmitter through signaling or other methods. In an alternative approach, signatures are computed from a formula and assignment/correspondence/mapping/association is provided to the transmitter through signaling or other methods by configuring the parameters/variables of the formula. A group-based signature is also denoted a “group-based identifier” or a “group identifier” hereinafter. The group-based signature may take different forms such as linear spreading, non-linear spreading, scrambling, cover code, symbol or bit interleaving, sparse symbol mapping, sparse spreading, and/or the like.

Similarly, a device-based signature is generally used for mitigating the intra-beam multi-user interference and exploiting the remaining intra-beam channel diversity, and may be considered an identifier assigned to or otherwise associated with a UE (similar to the conventional multiple-access (MA) signature) for uniquely identifying that a received wireless signal is associated with the UE identified by the device-based signature (for example, originated from the UE (if the wireless signal is received by the base station 112) or transmitted to the UE (if the wireless signal is received by the UE)).

In effect, device-based signature can be described as a signature assigned to or associated with or mapped to or corresponds to a single transmitter. A signature may be considered a unique identifier assigned to a transmission. Subsequently the signature is embedded or applied to the wireless signal transmitted in the transmission. In other words, signature is being used in the signal generation in the transmission blocks. In a typical system, signatures are listed or tabulated and then the assignment, correspondence, mapping, or association of the signatures is provided to the transmitter through signaling or other methods.

In an alternative approach, signatures are computed from a formula and assignment/correspondence/mapping/association is provided to the transmitter through signaling or other methods by configuring the parameters/variables of the formula. A device-based signature is also denoted a “UE-specific identifier” or a “UE-specific signature” hereinafter. Depending on the NoMA technologies used, the device-based signature may take different forms. Non-limiting examples of device-based signatures include linear spreading, non-linear spreading, scrambling, symbol or bit interleaving, sparse symbol mapping, and sparse spreading.

For example, in some embodiments, the device-based signature s of size F (F>1 is an integer), for example, a device-based signature s in the form of a linear spreading code with a spreading factor F, may be represented as a vector of length of F (that is, comprising F elements):

$$s = {[ s ( 0 ) , s ( 1 ) , … , s ( F - 1 ) ]}^{T} , \qquad ( 1 )$$

where [x]^{T} represents the transpose of vector or matrix x.

The group-based signature c is a code having a size F (that is, comprising F elements). In other words, the group-based signature c may be represented as a diagonal matrix of size F:

$$c = diag ( {[ c ( 0 ) , c ( 1 ) , … , c ( F - 1 ) ]}^{T} ) = [ \begin{matrix}c ( 0 ) & & & 0 \\ & c ( 1 ) & & \\ & & ⋱ & \\ 0 & & & c ( F - 1 )\end{matrix} ] , \qquad ( 2 )$$

where diag([x₁, x₂ . . . ]^{T}) represents a diagonal matrix with the diagonal elements thereof formed by the elements x₁, x₂, . . . of vector [x₁, x₂, . . . ]^{T}.

Then, a combined signature g is calculated as:

$$g = c s , \qquad ( 3 )$$

$$or$$

$$g = {[ g ( 0 ) , g ( 1 ) , … , g ( F - 1 ) ]}^{T} = {[ c ( 0 ) s ( 0 ) , c ( 1 ) s ( 1 ) , … , c ( F - 1 ) s ( F - 1 ) ]}^{T} .$$

In some embodiments, a combined signature g may be calculated as described above for each UE 114, and is then used for applying to the wireless signals transmitted between the UE 114 and the base station 112.

As those skilled in the art will appreciate, the mathematical representation in Equations (1) to (3) is only an exemplary approach and there are other ways to achieve the same desired result from different mathematical notations or operations. For example, Equation (3) may be written as element-wise multiplication.

In some embodiments, one or more measurements may be performed to obtain the communication conditions. For example, the base station 112 and/or UEs 114 may perform signaling in uplink or downlink or both directions to configure transmission parameters, NoMA signal generation, the association, mapping, or correspondence of beams/SSBs to group-based signatures, association or mapping/correspondence of beams/SSBs to the generation of reference signals, the group-based-signature pool, the device-based signature pool, the reference-signal pool (described in more detail later), signaling related to UE grouping, transmission resource allocation through explicit or implicit manner, and/or the like.

For example, the base station 112 communicates with a plurality of UEs 114 using a plurality of N beams for reference signal transmission and/or data transmission (uplink or downlink) therebetween, where N≥1 is an integer. The plurality of UEs 114 in the N beams may use the same physical resource 252 as shown in FIG. 7 for communication and may be referred as a communication occasion (CO). Alternatively, the plurality of UEs 114 in the N beams may use multiple physical resources for communication (that is, multiple COs (not shown in FIG. 7)).

The N beams may be transmitter beams or receiver beams. In these embodiments, the N beams are classified into K beam groups (K is an integer and 1≤K≤N) based on their measured or otherwise obtained communication conditions such as spatial diversities (for example, the angles between neighboring beams), levels of inter-beam interference, inter-beam correlation level, channel-correlation levels, traffic levels, TBS, transmission activity levels, and/or the like (for example, comparing to one or more thresholds). Such communication conditions may be measured or otherwise obtained by the RAN 102 or the base station 112 thereof, or may be reported by the UEs to the RAN 102 or the base station 112 thereof. Communication condition for grouping may be signaled or configured or reported by signaling such as RRC, MAC-CE, DCI. Alternatively, communication condition for grouping may be signaled or configured or reported via RRC release message or when RRC state transition messages or through paging messages.

The K beam groups may be obtained by comparing the obtained communication conditions with one or more communication-condition thresholds such that each beam group comprises one or more beams of similar communication conditions. Accordingly, the UEs 114 associated with the beams (that is, the UEs 114 using the beams for communication) are also classified into K UE groups. Such a classification is denoted a configuration hereinafter.

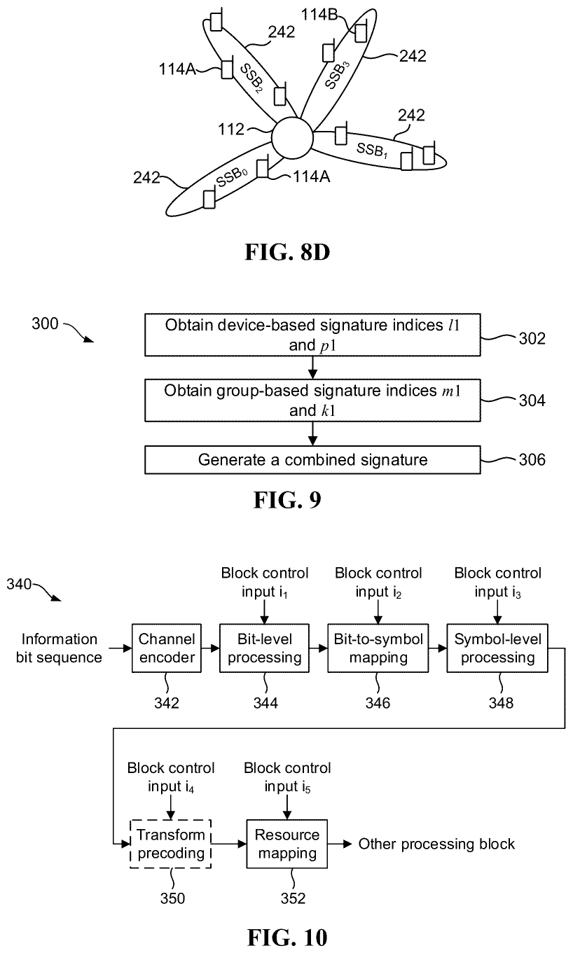

FIGS. 8A to 8D show examples of the grouping of four beams 242 (also identified using their SSB indices as SSB₀ to SSB₃) based on the beam-correlation levels thereof.

FIG. 8A shows a first configuration (configuration-0) wherein the four beams 242 are highly correlated (for example, the correlation between neighboring beams of SSB₀ to SSB₃ is greater than a predefined correlation threshold). Therefore, the four beams SSB₀ to SSB₃ are classified into one beam group 262. Accordingly, all UEs 114 are classified into one UE group (group-0).

FIG. 8B shows a second configuration (configuration-1) wherein beams SSB₀ to SSB₂ are spatially close to each other or highly correlated and therefore are classified into a first beam group 264. Accordingly, UEs 114A associated with beams SSB₀ to SSB₂ are classified into the first UE group (group-0).

The SSB₃ is spatially distant from other beams (for example, the angles between SSB₃ and other beams are smaller than the predefined angular threshold) or its correlations with other beams are smaller than the predefined correlation threshold) and therefore is classified into a second beam group 266. Accordingly, UEs 114B associated with beam SSB₃ are classified into the second UE group (group-1).

FIG. 8C shows a third configuration (configuration-2) wherein beams SSB₀ and SSB₁ are spatially close to each other or highly correlated and therefore are classified into a first beam group 268. Accordingly, UEs 114A associated with beams SSB₀ and SSB₁ are classified into the first UE group (group-0).

Beams SSB₂ and SSB₃ are spatially close to each other or highly correlated, but are spatially distant from beams SSB₀ and SSB₁ or having low correlations therewith. Therefore, beams SSB₂ and SSB₃ are classified into a second beam group 270. Accordingly, UEs 114B associated with beams SSB₂ and SSB₃ are classified into the second UE group (group-1).

FIG. 8D shows another configuration (configuration-3) wherein beams SSB₀ to SSB₄ are mutually spatially distant from each other or having low correlations therewith. Therefore, each of the beams SSB₀ to SSB₄ is classified as a beam group. Accordingly, UEs 114A associated with the beams SSB₀ to SSB₄ are classified into corresponding UE groups.

Table 1 summarizes the grouping of beams and UEs in the four configurations shown in FIGS. 8A to 8D.

As those skilled in the art will appreciate, the group of transmitters or UEs may be referred as a cluster of transmitters or UEs or a set of transmitters or UEs.

TABLE 1
BEAM GROUPING IN CONFIGURATIONS SHOWN IN FIGS. 8A TO 8D

| Beam/SSB | Group Index k in | Group Index k in | Group Index k in | Group Index k in |
|---|---|---|---|---|
| Index | Configuration-0 | Configuration-1 | Configuration-2 | Configuration-3 |
| 0 | 0 | 0 | 0 | 0 |
| 1 | 0 | 0 | 0 | 1 |
| 2 | 0 | 0 | 1 | 2 |
| 3 | 0 | 1 | 1 | 3 |

With above-described beam/UE classification, a device-based signature pool may be selected for each beam/UE group from a plurality of L (L≥1 is an integer) device-based signature pools S⁽⁰⁾, S⁽¹⁾, . . . , S^{(L-1)} for adapting to various intra-beam interferences and providing code- or signature-domain intra-beam collision mitigation via adaptive signature-domain separation. Each device-based signature pool S^{(l)} (L−1≥l≥0) comprises a set of P device-based signatures (P≥1 is an integer):

$${S}^{( l )} = \{ {s}_{0}^{( l )} , {s}_{1}^{( l )} , … , {s}_{P - 1}^{( l )} \} , \qquad ( 4 )$$

where {·} represents a set or an aggregation of the elements enclosed therein. Each device-based signature sₚ^{(l)}(P−1≥p≥0) is, for example, a linear spreading code with a spreading factor F (F>1 is an integer) and may be represented as a vector of length of F (that is, comprising F elements):

$${s}_{p}^{( l )} = {[ {s}_{p}^{( l )} ( 0 ) , {s}_{p}^{( l )} ( 1 ) , … , {s}_{p}^{( l )} ( F - 1 ) ]}^{T} . \qquad ( 5 )$$

where [x]^{T} represents the transpose of the vector or matrix x.

Table 2 summarizes the device-based signature pools.

TABLE 2
DEVICE-BASED SIGNATURE POOLS

| | |
|---|---|
| Device-based | Device-based signature pools |

| signature index | S⁽⁰⁾ | S⁽¹⁾ | . . . | S^{(L-1)} |
|---|---|---|---|---|
| 0 | s₀⁽⁰⁾ | s₀⁽¹⁾ | . . . | s₀^{(L-1)} |
| 1 | s₁⁽⁰⁾ | s₁⁽¹⁾ | . . . | s₁^{(L-1)} |
| . | . | . | . | · |
| . | . | . | . | . |
| . | . | . | . | . |
| P | s_{P-1}⁽⁰⁾ | s_{P-1}⁽¹⁾ | . . . | s_{P-1}^{(L-1)} |

Table 3 shows an example of a pair of device-based signature pools. As can be seen, P may be different for different device-based signature pools.

TABLE 3
EXAMPLE OF DEVICE-BASED SIGNATURE POOLS

| | |
|---|---|
| Device-based | Device-based signature pools |

| signature index | S⁽⁰⁾ | S⁽¹⁾ |
|---|---|---|
| 0 | [1, 1]^{T} | [1, 1, 1, 1]^{T} |
| 1 | [1, −1]^{T} | [1, j, −1, −j]^{T} |
| 2 | | [1, −j, −1, j]^{T} |
| 3 | | [1, −1, 1, −1]^{T} |

In the example shown in Table 3, the device-based signature pool S⁽⁰⁾ comprises two device-based signatures in the form of two length-2 linear spreading sequences [1, 1]^{T} and [1, −1]^{T} (that is, the spreading factor F=2). The sequences are orthogonal to each other (that is, the correlation therebetween is zero). The device-based signature pool S⁽¹⁾ comprises four device-based signatures in the form of four length-4 linear spreading sequences orthogonal to each other.

A group-based signature pool may be selected for the beam/UE groups from a plurality of M (M≥1 is an integer) group-based signature pools C⁽⁰⁾, C⁽¹⁾, . . . , C^{(M-1)} for adapting to various correlation levels between beams and providing inter-beam collision mitigation by the combination of code domain and remaining channel diversity. Each group-based signature pool C^{(m)} (M−1≥m≥0) comprises a set of K group-based signatures:

$${C}^{( m )} = \{ {c}_{0}^{( m )} , {c}_{1}^{( m )} , … , {c}_{K - 1}^{( m )} \} , \qquad ( 6 )$$

where K is the number of groups (for example, the number of beams) in the k-th beam group (K−1≥k≥0) and each group-based signature cₖ^{(m)} (K−1≥k≥0) is a size-F diagonal matrix:

$$( 7 )$$

$${c}_{k}^{( m )} = diag ( {[ {c}_{k}^{( m )} ( 0 ) , {c}_{k}^{( m )} ( 1 ) , … , {c}_{k}^{( m )} ( F - 1 ) ]}^{T} ) = [ \begin{matrix}{c}_{k}^{( m )} ( 0 ) & & & 0 \\ & {c}_{k}^{( m )} ( 1 ) & & \\ & & ⋱ & \\ 0 & & & {c}_{k}^{( m )} ( F - 1 )\end{matrix} ] ,$$

Table 4 summarizes the group-based signature pool.

TABLE 4
GROUP-BASED SIGNATURE POOLS

| | |
|---|---|
| Group-based | Group-based signature pools |

| signature index | C⁽⁰⁾ | C⁽¹⁾ | . . . | C^{(M-1)} |
|---|---|---|---|---|
| 0 | c₀⁽⁰⁾ | c₀⁽¹⁾ | . . . | c₀^{(M-1)} |
| 1 | c₁⁽⁰⁾ | c₁⁽¹⁾ | . . . | c₁^{(M-1)} |
| . | . | . | . | . |
| . | . | . | . | . |
| . | . | . | . | . |
| K | c_{K-1}⁽⁰⁾ | c_{K-1}⁽¹⁾ | . . . | c_{K-1}^{(M-1)} |

Table 5 shows an example of three group-based signature pools.

TABLE 5
EXAMPLE OF GROUP-BASED SIGNATURE POOLS

| Group-based | Group-based signature pools | | |
|---|---|---|---|
| signature index | C⁽⁰⁾ | C⁽¹⁾ | C⁽²⁾ |
| 0 | diag([1, 1]^{T}) | diag([1, 1, 1, 1]^{T}) | diag([1, 1, 1, 1])^{T}) |
| 1 | diag([1, j]^{T}) | diag([1, 1, −j, −j]^{T}) | diag([1, 1, −1, −1]^{T}) |
| 2 | | | diag([1, 1, −j, −j]^{T}) |
| 3 | | | diag([1, 1, j, −j]^{T}) |

In the example shown in Table 5, the group-based signature pool C⁽⁰⁾ comprises group-based signatures diag([1, 1]^{T}) and diag([1, j]^{T}) each having a size of two (2), and “size-2” means that the size of the diagonal matrix is two (or in other words, the number of elements in the diagonal of the matrix is two), and matches the device-based signature pool S⁽⁰⁾. Each of the group-based signature pools C⁽¹⁾ and C⁽²⁾ comprises a plurality of group-based signatures (each of which has a size of four (4)), and matches the device-based signature pool S⁽¹⁾.

FIG. 9 is a flowchart showing a process 300 for generating a combined signature (combining the device-based and group-based signatures) for a UE 114 of the k1-th beam/UE group (K−1≥k1≥0) of the K beam/UE groups after the beams/UEs have been classified into the K groups based on the inter-beam/inter-group interference as described above.

At step 302, a device-based signature pool index l1 (L−1≥l1≥0) is obtained, and then a device-based signature index p1 (P−1≥p1≥0) is obtained for the UE 114.

The selection of the device-based signature pool may be based on the UEs in a beam/UE group (including a beam group having only a single beam). For example, if there are many UEs in a beam group, a device-based signature pool of a large size (that is, a device-based signature pool with a large P) may be selected. The selection of the device-based signature pool may also be based on the long-term slow varying system parameters such as the number of UEs, the number of transmit/receive antennas, the UE distribution within the beam-group, the level of intra-group correlation, and/or the like.

After a device-based signature pool is selected, the device-based signatures of the selected pool may be applied to or otherwise associated with the UEs of the beam/UE group. For example, in grant-free transmission, the device-based signature index p1 may be a randomly generated index. In grant based transmission, the device-based signature index p1 may be assigned by a device (for example, the base station 112). By using the indices l1 and p1, a device-based signature sₚ₁^{(l1)} is selected or otherwise obtained from the selected device-based signature pool.

At step 304, a group-based signature pool index m1 (M−1≥m1≥0) is selected for the beam/UE groups. The selection of the group-based signature pool index m1 may be based on long-term slow varying system parameters such as beam-correlation level, number of active beams, antenna array size, beam forming method (analog/digital/hybrid), cell size, deployment scenario, and/or the like.

Then, the group-based signature index for the UE 114 of the k1-th beam/UE group is selected as k1. By using the indices m1 and k1, a group-based signature cₖ₁^{(m1)} is selected or otherwise obtained from the selected group-based signature pool.

At step 306, the combined signature for the UE 114 of the k1-th beam/UE group is obtained as:

$$g = {[ {c}_{k 1}^{( m 1 )} ( 0 ) {s}_{p 1}^{( l 1 )} ( 0 ) , {c}_{k 1}^{( m 1 )} ( 1 ) {s}_{p 1}^{( l 1 )} ( 1 ) , … , {c}_{k 1}^{( m 1 )} ( F - 1 ) {s}_{p 1}^{( l 1 )} ( F - 1 ) ]}^{T} . \qquad ( 8 )$$

The combined signature g is then used as a signature for generating a NoMA signal (that is, a data-bearing signal using NoMA technologies) for transmission between the UE 114 of the k1-th beam/UE group and the base station 112.

As those skilled in the art will appreciate, the group-based signature may be considered a rotation applied to the device-based signature pool. Alternatively, other operations may be performed such reflection or projection or alignment of the device-based signature pool to another dimension so that the resulting device-based signature achieves the desired outcome such as low interference in certain desired direction, minimizing the interference in a certain direction, maximizing the signal-to-interference-and-noise-ratio (SINR) in a certain direction, and/or the like. Reflection may mean the mirror image of the vector on a hyperplane. Projection may refer to the vector projection onto a hyperplane. Alignment may mean rotation, reflection, projection, or other operations so that certain operation on the device-based signature is performed to achieve the desired outcome.

By using a plurality of device-based signature pools and group-based signature pools, the system 100 may support varying number of UEs per beam (for example, randomly active UEs) with the grouping and/or varying amount of correlation/interference levels (including both intra-beam and inter-beam interferences).

For example, the device-based signature pool S⁽⁰⁾ shown in Table 3 and the group-based signature pool C⁽⁰⁾ shown in Table 5 are suitable for a small number of potentially active UEs. On the other hand, the device-based signature pool S⁽¹⁾ shown in Table 3 and the group-based signature pool C⁽¹⁾ or C⁽²⁾ shown in Table 5 are suitable for a large number of potentially active UEs.

As those skilled in the art will appreciate, wireless signals for NoMA transmission may be generated using one or more signatures with various methods such as symbol-level operations, bit-level operations, or a combination thereof. Symbol-level operations may include spreading (linear or non-linear), scrambling, sparse spreading/mapping, and the like. Bit-level operations may include bit scrambling, interleaving, bit repetition, puncturing, pruning, and the like.

For example, symbols may be spread symbols. Spread symbols may be symbol spread with linear spreading or non-linear spreading. In linear spreading, spread symbols have a linear relationship among them. For example, a symbol s1 spread with spreading sequence [1, −1] produces a symbol sequence [s1, −s1] and s1 spread with spreading sequence [1, 1] produces a symbol sequence [s1, s1].

On the other hand, in non-linear spreading, the relationship between the spread symbols is associated with the mapping bits. For example, bits 00, 01, 10 may map to symbols s1, s2, s3, and then bit sequence 010 may be spread to 0110 (by duplicating the middle bit) and map to symbol sequence [s2, s3] and bit sequence 101 may be spread to 1001 and map to symbol sequence [s3, s2]. As such the relationship of the symbols is defined in the bit domain. Non-linear spreading may be referred to as multidimensional modulation as well. As such by defining a bits to symbol mapping (in a table format or in a constellation), non-linear spreading may be achieved.

The spreading may be sparse spreading or non-sparse spreading. In sparse spreading, spreading involves zero symbol (a symbol “0” with zero power). For example, symbol s1 sparse-spread by sparse sequence [1, 0] produces symbol sequence [s1, 0]. Sparse spreading may also refer to as sparse mapping. The symbols may be scrambled symbols. For example, symbol sequence [s1, s2] scrambled by scrambling sequence [1, −1] produces the symbol sequence [s1, −s2]. Symbols may be multiplied by a cover code, that is, symbol sequence [s1, s2] scrambled by scrambling sequence [1, −1] produces the symbol sequence [s1, −s2]. Other symbol domain operations such as symbol interleaving may be performed (changing the location of the symbols, symbol permutation).

The symbols may be generated after bit-domain process or operation such as bit interleaving, bit repetition, bit permutation, bit scrambling, bit puncturing or bit pruning. Bit interleaving may refer to a change of bit location. Bit scrambling may refer to exclusive-OR (XOR) with a known/given another bit sequence (for example, XOR the encoded information bit sequence with a known bit sequence such as the identifier (ID) of the UE (UE_ID) where UE_ID is a Radio Network Temporary Identifier (RNTI)). Bit permutation may mean the permuting the bit location. Bit puncturing or pruning may mean removing certain bits. A signature and/or NoMA signal may be produced by combination of bit and/or symbol domain processes or operations. For example, linear spreading together with bit interleaving may produce a NoMA signal. In another example, symbol spreading with symbol scrambling may produce a NoMA signal. In yet another example, bit interleaving and bit scrambling may produce a NoMA signal. A combination of symbol domain, bit domain or both may produce a NoMA signal.

Such symbol-level or bit-level operations may be used for embedding or otherwise applying one or more signatures, such as the device-based signature and/or the group-based signature, to the signal generated at the transmitter side (for example, one of the corresponding UE 114 and the base station 112). Then, at the receiver side (for example, the other of the corresponding UE 114 and the base station 112), the signatures embedded in the transmitted signal are exploited at the receiver side to separate the signals.

For example, in some embodiments, the combined signature (obtained from the device-based signature and the group-based signature) may be embedded or otherwise applied to the wireless signal via a bit-level operation. In some other embodiments, the combined signature may be embedded or otherwise applied to the wireless signal via a symbol-level operation.

In some other embodiments, no combined signature is calculated. Rather, the device-based signature and the group-based signature may be separately embedded or otherwise applied to the wireless signals.

For example, in some embodiments, the device-based signature is embedded or otherwise applied to the wireless signals via a bit-level operation and the group-based signature is embedded or otherwise applied to the wireless signals via a symbol-level operation.

In some embodiments, the device-based signature is embedded or otherwise applied to the wireless signals via a symbol-level operation and the group-based signature is embedded or otherwise applied to the wireless signals via a bit-level operation.

In some embodiments, the device-based signature and the group-based signature are separately embedded or otherwise applied to the wireless signals via bit-level operations.

In some embodiments, the device-based signature and the group-based signature are separately embedded or otherwise applied to the wireless signals via symbol-level operations.

In embodiments where the device-based signature and the group-based signature are separately applied to the wireless signals, either one of the device-based signature and the group-based signature may be applied first and the other thereof may be applied thereafter.

In some scenario, without any symbol-level or bit-level operations (that is, without embedding a signature at the transmitter side) each transmitter generates a signal and may be transmitted over the same physical resource. Therefore, multiple transmissions from multiple transmitters (such as UEs 114) collide each other and such collision-based transmission may be considered a NoMA transmission or multi-user multiple-input multiple-output (MIMO) or contention-based transmission. As such, in this scenario, signals from different transmitters does not perform any bit-level or symbol-level operations on the signal and each signal is a regular transmission without embedding any signature but separated at the receiver using multiple antenna reception. Such generation of a NoMA signal by embedding or using a signature or without embedding signature may corresponds to a NoMA method.

In some embodiments, a plurality of group-based signatures may be embedded or otherwise applied to the wireless signals of a UE 114. For example, in one embodiment, two group-based signatures c₁ and c₂ may be combined into a combined group-based signature (in a manner similar to above-described combining of the group-based signature and the device-based signature) and then embedded or otherwise applied to the wireless signals of a UE 114.

In another embodiment, the two group-based signatures c₁ and c₂ may be separately applied to the wireless signal. For example, c₁ may be first applied to the wireless signal (which may or may not have been processed by the device-based signature s) and then c₂ is applied to the wireless signal that has been processed by c₁. Such an operation may be considered a cascaded operation of group-based signatures.

Each of the plurality of group-based signatures may be applied to the wireless signal for a specific purpose. For example, c₁ may be used for adjusting the phase of s and c₂ may be used for adjusting the amplitude of s, wherein s may represent the NoMA wireless signal, device-based signature, modulated symbols, or modulated symbol sequence with or without embedded device-based signature. For example, s may be a NoMA wireless signal or sequence of symbols generated from linear spreading (wherein the linear spreading sequence is a device-based signature embedded in s) and one or more group-based signatures may be applied on s. In another example, s may be a sequence of modulated symbols such as π/2-BPSK, BPSK, QPSK, 16-QAM or m-QAM (where m=4, 16, 256, 1024, . . . ) generated from a modulator and one or more group-based signatures may be applied on s. In addition to one or more group-based signatures, other operations may be performed on NoMA wireless signal such as power adjustment, scaling, control, and/or the like.

In another example, c₁ may adjust the phase of s for long-term phase/channel variations while c₂ may adjust the phase of c₁ s for short-term phase/channel variations.

As described above, in some embodiments, the group-based signature may be in bit domain. For example, a group-based signature in the form of group based scrambling may be applied in encoded bits or the combination of information bits and the device-based signature, and the sequence of modulated symbols or NoMA wireless signal may be generated from the scrambled bits.

In some embodiments, the group-based signature is applied in bit level and the device-based signature may or may not be applied in bit or symbol level. For example, the group-based signature is applied based on the group or beam at bit level by bit scrambling or bit interleaving, and then modulated symbols are generated and sparsely mapped to generate a NoMA signal, wherein the sparse mapping may be considered embedding the device-based signature while beam-based/group-based scrambling is considered embedding the group-based signature. In another example, beam-based/group-based scrambling is applied (which may be considered embedding the group-based signature) and then a modulator uses the scrambled bits to generate modulated symbols such as π/2-BPSK, BPSK, QPSK, 16-QAM or m-QAM (where m=4, 16, 256, 1024, . . . ) wherein the generation of the modulated symbols may be considered applying the device-based signature.

In above embodiments, the device-based signatures in a device-based signature pool are orthogonal to each other. In some alternative embodiments, the device-based signatures in a device-based signature pool may not be mutually orthogonal. Those skilled in the art will appreciate that the device-based signatures in a device-based signature pool may be suitable to use when they can provide sufficient probability of confidence in correctly retrieving information from the received wireless signals (which may contain noise and interferences).

Similarly, the group-based signatures in a group-based signature pool may be mutually orthogonal in some embodiments and may not be mutually orthogonal in some other embodiments. Those skilled in the art will appreciate that the group-based signatures in group-based signature pool may be suitable to use when they can provide sufficient probability of confidence in correctly retrieving information from the received wireless signals (which may contain noise and interferences).

In some alternative embodiments, other linear spreading sequences with other spreading lengths and/or with other value spaces (for example, real values) may be used as the device-based signatures.

In some embodiments, the device-based signatures and group-based signatures described above may be used in various NoMA technologies such as SCMA, IGMA, IDMA, PDMA, RSMA, and the like.

FIG. 10 is a simplified block diagram showing a process 340 for generating a NoMA signal. As shown, the information bit sequence is first encoded using a channel encoder 342 for forward error correction such as polar code, LDPC, turbo code, linear block code (for example, Bose-Chaudhuri-Hocquenghem (BCH) code), convolution code, and/or the like, and produces a coded or encoded bit sequence. Channel encoding may also include other operations such as CRC (cyclic redundancy check), rate matching, hybrid-ARQ related operations.

The coded/encoded bit sequence is further processed by a bit-level processing block 344 which may include one or more of bit-interleaving, bit scrambling, puncturing, pruning, bit-repetition and other bit-level processing. The output of the bit-level processing block 344 is sent to a bit-to-symbol mapping block 346.

In various embodiments, the bit-level processing block 344 may partially or fully embed a device-based signature or a group-based signature or both. Alternatively, the bit-level processing block 344 may not be used for embedding the device-based and group-based signatures, and other blocks such as the symbol-level processing block 348 may be used for embedding the device-based and group-based signatures.

For example, in some embodiments, the bit-level processing block 344 may, at least in part, embed a device-based signature to the sequence of coded bits. For example, UE-specific bit-interleaving or block-interleaving may be considered embedding a device-based signature and the output of the bit-level processing block 344, after processed by other blocks, generates a NoMA signal. As another example, the bit level-processing block 344 may embed a group-based signature to the sequence of coded bits. For example, based on the beam or grouping, coded bit sequence may be scrambled and the output of the bit-level processing block 344, after processed by other blocks, generates a NoMA signal. This scrambling may be performed using beam-specific identifier or beam-group-specific identifier. As such, sequence of bits output from the bit-level processing block 344 may comprise a device-based signature (in its entirety or in part) or a group-based signature (in its entirety or in part) or both. The operations of the bit-level processing block 344 may be controlled or configured by the input control signaling i₁ to operate in a certain way to produce the desired output. For example, certain i₁ value may indicate device-based bit-interleaving, another value for i₁ indicates group-based bit-scrambling, yet another value of i₁ may indicate device-based bit-interleaving and group-based bit-scrambling. In this example, the group-based bit-scrambling (at least in parts) performs operations required for group-based signature embedding to the output, device-based bit-interleaving (at least in parts) performs operations required for device-based signature embedding to the output.

When bit-level processing is not required, this block 344 is eliminated/removed and output of the channel encoder block 342 is connected to the bit-to-symbol mapping block 346. For example, the bit-level processing block may not be required if the device-based and group-based signatures are not embedded in bit-level processing.

The bit-to-symbol mapping block 346 maps the bit sequence to a sequence of symbols. For example, bit-to-symbol mapping may be modulation operation such as π/2-BPSK, BPSK, QPSK, 16-QAM or m-QAM where m=4, 16, 256, 1024 (legacy modulation). Bit-to-symbol mapping may use the bit-to-symbol mapping method defined in Modulation mapper in 3GPP TS 38.211 V17.0.0 (2021-12) (legacy NR modulation). In another example, the m1-bit to n1-symbol mapping may be represented by a table in which each column represents the symbol sequence in term of an index of the input bit stream. Such mapping tables for mapping directly to two symbols are shown below. Tables 6 to 8 may represent multi-dimensional modulation or non-linear spreading.

TABLE 6
MAPPING FUNCTION FOR THE 8-POINT MODULATED SYMBOL
SEQUENCE OF LENGTH-TWO

| Sequence index | 1 | 2 | 3 | 4 |
|---|---|---|---|---|
| Corresponding | 000 | 001 | 010 | 011 |
| bit sequence | | | | |
| Output symbol sequence | $[ \begin{matrix}- {a}_{8} + {jb}_{8} \\ - {a}_{8} + {jb}_{8}\end{matrix} ]$ | $[ \begin{matrix}{a}_{8} + {jb}_{8} \\ {a}_{8} + {jb}_{8}\end{matrix} ]$ | $[ \begin{matrix}- {a}_{8} - {jb}_{8} \\ - {a}_{8} + {jb}_{8}\end{matrix} ]$ | $[ \begin{matrix}{a}_{8} - {jb}_{8} \\ {a}_{8} + {jb}_{8}\end{matrix} ]$ |
| Sequence index | 5 | 6 | 7 | 8 |
| Corresponding | 100 | 101 | 110 | 111 |
| bit sequence | | | | |
| Output symbol sequence | $[ \begin{matrix}- {a}_{8} + {jb}_{8} \\ - {a}_{8} - {jb}_{8}\end{matrix} ]$ | $[ \begin{matrix}{a}_{8} + {jb}_{8} \\ {a}_{8} - {jb}_{8}\end{matrix} ]$ | $[ \begin{matrix}- {a}_{8} - {jb}_{8} \\ - {a}_{8} - {jb}_{8}\end{matrix} ]$ | $[ \begin{matrix}{a}_{8} - {jb}_{8} \\ {a}_{8} - {jb}_{8}\end{matrix} ]$ |

where with a₈=0.5774 and b₈=0.8165.

TABLE 7
MAPPING FUNCTION FOR THE 16-POINT MODULATED SYMBOL
SEQUENCE OF LENGTH-TWO

| Sequence index | 1 | 2 | 3 | 4 | 5 | 6 | 7 | 8 |
|---|---|---|---|---|---|---|---|---|
| Corresponding | 0000 | 0001 | 0010 | 0011 | 0100 | 0101 | 0110 | 0111 |
| bit sequence | | | | | | | | |
| Output Symbol sequence | $[ \begin{matrix}3 + 3 j \\ 1 + j\end{matrix} ]$ | $[ \begin{matrix}- 1 + 3 j \\ 3 + j\end{matrix} ]$ | $[ \begin{matrix}1 + 3 j \\ - 3 + j\end{matrix} ]$ | $[ \begin{matrix}- 3 + 3 j \\ - 1 + j\end{matrix} ]$ | $[ \begin{matrix}3 - j \\ 1 + 3 j\end{matrix} ]$ | $[ \begin{matrix}- 1 - j \\ 3 + 3 j\end{matrix} ]$ | $[ \begin{matrix}1 - j \\ - 3 + 3 j\end{matrix} ]$ | $[ \begin{matrix}- 3 - j \\ - 1 + 3 j\end{matrix} ]$ |
| Sequence index | 9 | 10 | 11 | 12 | 13 | 14 | 15 | 16 |
| Corresponding | 1000 | 1001 | 1010 | 1011 | 1100 | 1101 | 1110 | 1111 |
| bit sequence | | | | | | | | |
| Output Symbol sequence | $[ \begin{matrix}3 + j \\ 1 - 3 j\end{matrix} ]$ | $[ \begin{matrix}- 1 + j \\ 3 - 3 j\end{matrix} ]$ | $[ \begin{matrix}1 + j \\ - 3 - 3 j\end{matrix} ]$ | $[ \begin{matrix}- 3 + j \\ - 1 - 3 j\end{matrix} ]$ | $[ \begin{matrix}3 - 3 j \\ 1 - j\end{matrix} ]$ | $[ \begin{matrix}- 1 - 3 j \\ 3 - j\end{matrix} ]$ | $[ \begin{matrix}1 - 3 j \\ - 3 - j\end{matrix} ]$ | $[ \begin{matrix}- 3 - 3 j \\ - 1 - j\end{matrix} ]$ |

TABLE 8
MAPPING FUNCTION FOR THE 64-POINT MODULATED SYMBOL
SEQUENCE OF LENGTH-TWO

| Sequence index | 1 | 2 | 3 | 4 | 5 | 6 | 7 | 8 |
|---|---|---|---|---|---|---|---|---|
| Corresponding | 000 000 | 000 001 | 000 010 | 000 011 | 000 100 | 000 101 | 000 110 | 000 111 |
| bit sequence | | | | | | | | |
| Output symbol sequence | $[ \begin{matrix}1 + j \\ 1 + j\end{matrix} ]$ | $[ \begin{matrix}1 + 3 j \\ 1 + 3 j\end{matrix} ]$ | $[ \begin{matrix}1 - j \\ 1 + j\end{matrix} ]$ | $[ \begin{matrix}1 - 3 j \\ 1 + 3 j\end{matrix} ]$ | $[ \begin{matrix}3 + j \\ 3 + j\end{matrix} ]$ | $[ \begin{matrix}3 + 3 j \\ 3 + 3 j\end{matrix} ]$ | $[ \begin{matrix}3 - j \\ 3 + j\end{matrix} ]$ | $[ \begin{matrix}3 - 3 j \\ 3 + 3 i\end{matrix} ]$ |
| Sequence index | 9 | 10 | 11 | 12 | 13 | 14 | 15 | 16 |
| Corresponding | 001 000 | 001 001 | 001 010 | 001 011 | 001 100 | 001 101 | 001 110 | 001 111 |
| bit sequence | | | | | | | | |
| Output symbol sequence | $[ \begin{matrix}- 1 + j \\ 1 + j\end{matrix} ]$ | $[ \begin{matrix}- 1 + 3 j \\ 1 + 3 j\end{matrix} ]$ | $[ \begin{matrix}- 1 - j \\ 1 + j\end{matrix} ]$ | $[ \begin{matrix}- 1 - 3 j \\ 1 + 3 j\end{matrix} ]$ | $[ \begin{matrix}- 3 + j \\ 3 + j\end{matrix} ]$ | $[ \begin{matrix}- 3 + 3 j \\ 3 + 3 j\end{matrix} ]$ | $[ \begin{matrix}- 3 - j \\ 3 + j\end{matrix} ]$ | $[ \begin{matrix}- 3 - 3 j \\ 3 + 3 j\end{matrix} ]$ |
| Sequence index | 17 | 18 | 19 | 20 | 21 | 22 | 23 | 24 |
| Corresponding | 010 000 | 010 001 | 010 010 | 010 011 | 010 100 | 010 101 | 010 110 | 010 111 |
| bit sequence | | | | | | | | |
| Output symbol sequence | $[ \begin{matrix}1 + j \\ 1 - j\end{matrix} ]$ | $[ \begin{matrix}1 + 3 j \\ 1 - 3 j\end{matrix} ]$ | $[ \begin{matrix}1 - j \\ 1 - j\end{matrix} ]$ | $[ \begin{matrix}1 - 3 j \\ 1 - 3 j\end{matrix} ]$ | $[ \begin{matrix}3 + j \\ 3 - j\end{matrix} ]$ | $[ \begin{matrix}3 + 3 j \\ 3 - 3 j\end{matrix} ]$ | $[ \begin{matrix}3 - j \\ 3 - j\end{matrix} ]$ | $[ \begin{matrix}3 - 3 j \\ 3 - 3 j\end{matrix} ]$ |
| Sequence index | 25 | 26 | 27 | 28 | 29 | 30 | 31 | 32 |
| Corresponding | 011 000 | 011 001 | 011 010 | 011 011 | 011 100 | 011 101 | 011 110 | 011 111 |
| bit sequence | | | | | | | | |
| Output symbol sequence | $[ \begin{matrix}- 1 + j \\ 1 - j\end{matrix} ]$ | $[ \begin{matrix}- 1 + 3 j \\ 1 - 3 j\end{matrix} ]$ | $[ \begin{matrix}- 1 - j \\ 1 - j\end{matrix} ]$ | $[ \begin{matrix}- 1 - 3 j \\ 1 - 3 i\end{matrix} ]$ | $[ \begin{matrix}- 3 + j \\ 3 - j\end{matrix} ]$ | $[ \begin{matrix}- 3 + 3 j \\ 3 - 3 j\end{matrix} ]$ | $[ \begin{matrix}- 3 - j \\ 3 - j\end{matrix} ]$ | $[ \begin{matrix}- 3 - 3 j \\ 3 - 3 j\end{matrix} ]$ |
| Sequence index | 33 | 34 | 35 | 36 | 37 | 38 | 39 | 40 |
| Corresponding | 100 000 | 100 001 | 100 010 | 100 011 | 100 100 | 100 101 | 100 110 | 100 111 |
| bit sequence | | | | | | | | |
| Output Symbol sequence | $[ \begin{matrix}1 + j \\ - 1 + j\end{matrix} ]$ | $[ \begin{matrix}1 + 3 j \\ - 1 + 3 j\end{matrix} ]$ | $[ \begin{matrix}1 - j \\ - 1 + i\end{matrix} ]$ | $[ \begin{matrix}1 - 3 j \\ - 1 + 3 j\end{matrix} ]$ | $[ \begin{matrix}3 + j \\ - 3 + j\end{matrix} ]$ | $[ \begin{matrix}3 + 3 j \\ - 3 + 3 j\end{matrix} ]$ | $[ \begin{matrix}3 - j \\ - 3 + j\end{matrix} ]$ | $[ \begin{matrix}3 - 3 j \\ - 3 + 3 j\end{matrix} ]$ |
| Sequence index | 41 | 42 | 43 | 44 | 45 | 46 | 47 | 48 |
| Corresponding | 101 000 | 101 001 | 101 010 | 101 011 | 101 100 | 101 101 | 101 110 | 101 111 |
| bit sequence | | | | | | | | |
| Output Symbol sequence | $[ \begin{matrix}- 1 + j \\ - 1 + j\end{matrix} ]$ | $[ \begin{matrix}- 1 + 3 j \\ - 1 + 3 j\end{matrix} ]$ | $[ \begin{matrix}- 1 - j \\ - 1 + j\end{matrix} ]$ | $[ \begin{matrix}- 1 - 3 j \\ - 1 + 3 j\end{matrix} ]$ | $[ \begin{matrix}- 3 + j \\ - 3 + j\end{matrix} ]$ | $[ \begin{matrix}- 3 + 3 j \\ - 3 + 3 j\end{matrix} ]$ | $[ \begin{matrix}- 3 - j \\ - 3 + j\end{matrix} ]$ | $[ \begin{matrix}- 3 - 3 j \\ - 3 + 3 j\end{matrix} ]$ |
| Sequence index | 49 | 50 | 51 | 52 | 53 | 54 | 55 | 56 |
| Corresponding | 110 000 | 110 001 | 110 010 | 110 011 | 110 100 | 110 101 | 110 110 | 110 111 |
| bit sequence | | | | | | | | |
| Output Symbol sequence | $[ \begin{matrix}1 + j \\ - 1 - j\end{matrix} ]$ | $[ \begin{matrix}1 + 3 j \\ - 1 - 3 j\end{matrix} ]$ | $[ \begin{matrix}1 - j \\ - 1 - j\end{matrix} ]$ | $[ \begin{matrix}1 - 3 j \\ - 1 - 3 j\end{matrix} ]$ | $[ \begin{matrix}3 + j \\ - 3 - j\end{matrix} ]$ | $[ \begin{matrix}3 + 3 j \\ - 3 - 3 j\end{matrix} ]$ | $[ \begin{matrix}3 - j \\ - 3 - j\end{matrix} ]$ | $[ \begin{matrix}3 - 3 j \\ - 3 - 3 j\end{matrix} ]$ |
| Sequence index | 57 | 58 | 59 | 60 | 61 | 62 | 63 | 64 |
| Corresponding | 111 000 | 111 001 | 111 010 | 111 011 | 111 100 | 111 101 | 111 110 | 111 111 |
| bit sequence | | | | | | | | |
| Output Symbol sequence | $[ \begin{matrix}- 1 + j \\ - 1 - j\end{matrix} ]$ | $[ \begin{matrix}- 1 + 3 j \\ - 1 - 3 j\end{matrix} ]$ | $[ \begin{matrix}- 1 - j \\ - 1 - j\end{matrix} ]$ | $[ \begin{matrix}- 1 - 3 j \\ - 1 - 3 j\end{matrix} ]$ | $[ \begin{matrix}- 3 + j \\ - 3 - j\end{matrix} ]$ | $[ \begin{matrix}- 3 + 3 j \\ - 3 - 3 j\end{matrix} ]$ | $[ \begin{matrix}- 3 - j \\ - 3 - j\end{matrix} ]$ | $[ \begin{matrix}- 3 - 3 j \\ - 3 - 3 j\end{matrix} ]$ |

Mapping to four symbols suitable for coverage limited case is shown below due to the low-PAPR property. Table 9 may represent linear spreading.

TABLE 9
THREE MAPPING FUNCTIONS WITH 4-POINT LOW PAPR
MODULATED SYMBOL OF LENGTH 4

| Sequence index | 1 | 2 | 3 | 4 |
|---|---|---|---|---|
| Corresponding bit sequence | 00 | 01 | 10 | 11 |
| Output symbol sequence | $[ \begin{matrix}1 \\ 1 \\ 1 \\ 1\end{matrix} ]$ | $[ \begin{matrix}1 \\ - j \\ - 1 \\ j\end{matrix} ]$ | $[ \begin{matrix}- 1 \\ j \\ 1 \\ - j\end{matrix} ]$ | $[ \begin{matrix}- 1 \\ - 1 \\ - 1 \\ - 1\end{matrix} ]$ |
| Sequence index | 1 | 2 | 3 | 4 |
| Corresponding bit sequence | 00 | 01 | 10 | 11 |
| Output symbol sequence | $[ \begin{matrix}1 \\ 1 \\ 1 \\ 1\end{matrix} ]$ | $[ \begin{matrix}1 \\ j \\ - 1 \\ - j\end{matrix} ]$ | $[ \begin{matrix}- 1 \\ - j \\ 1 \\ j\end{matrix} ]$ | $[ \begin{matrix}- 1 \\ - 1 \\ - 1 \\ - 1\end{matrix} ]$ |
| Sequence index | 1 | 2 | 3 | 4 |
| Corresponding bit sequence | 00 | 01 | 10 | 11 |
| Output symbol sequence | $[ \begin{matrix}1 \\ j \\ - 1 \\ - j\end{matrix} ]$ | $[ \begin{matrix}1 \\ - j \\ - 1 \\ j\end{matrix} ]$ | $[ \begin{matrix}- 1 \\ j \\ 1 \\ - j\end{matrix} ]$ | $[ \begin{matrix}- 1 \\ - j \\ 1 \\ j\end{matrix} ]$ |

The mapping function may also be presented by a formula expressing the relation between the input bit stream b and the output symbol sequence x. For example, the formula of 8-point modulated symbol sequence of length-two may be given as:

$$x = \sqrt{\frac{2}{3}} [ \begin{matrix}- \frac{1}{\sqrt{2}} & j & 0 \\ - \frac{1}{\sqrt{2}} & 0 & j\end{matrix} ] ( 1 - 2 b ) \qquad ( 9 )$$

where b is the information bit sequence of length-three (also shown in the table) and x is the output two symbols. As those skilled in the art will appreciate, the two symbols in x have a relationship defined by the input bits. This is known as non-linear spreading. Moreover, a block of bits (3 bits in this example) produces two symbols in one step, this process may also be referred as multi-dimensional modulation. The bits-to-symbol mapping block 346 may embed a device-based or group based signature (fully or partially) to the output sequence of symbols. The operations may be controlled or configured by the input control signaling i₂. For example, one value of i₂ indicates that bits-to-symbol mapping block 346 performs legacy modulation, another value of i₂ indicates that bits-to-symbol mapping block 346 performs multi-dimensional modulation or non-linear spreading, yet another value of i₂ indicates that bits-to-symbol mapping block 346 performs linear spreading etc.

The output sequence of symbols from bit-to-symbol mapping 346 is further processed by the symbol-level processing block 348 which may include spreading operations, symbol level scrambling, sparse mapping, symbol interleaving, symbol repetition, and/or the like. Spread symbols may be symbol spread with linear spreading or non-linear spreading.

As described before, in linear spreading, spread symbols have a linear relationship among them. For example, a symbol s1 spread with spreading sequence [1, −1] produces the symbol sequence [s1, −s1]. This spreading operation is performed by the symbol-level processing block 348. The linear spreading may be achieved by the bit-to-symbol mapping block 346 by defining in table format or in a formula. Such a table representation example is given in Table 9.

On other hand, in non-linear spreading, the relationship between the spread symbols is associated with the mapping bits. For example, bits 00, 01, 10 may map to symbols s1, s2, s3 and bit sequence 010 spread to 0110 (by duplicating the middle bit) and mapping, symbol sequence s2, s3 is obtained. Such non-linear spreading may also be achieved by formula as shown in Equation (9) or table shown in Tables 6 to 9. Therefore, non-linear spreading may also be achieved by the bit-to-symbol mapping block 346.

Alternatively, non-linear spreading may be generated in the symbol-level processing block 348. As such, the relationship of the symbols is defined in the bit domain. Non-linear spreading may be referred to as multidimensional modulation as well. As such, by defining a bit-to-symbol mapping (in a table format or in a constellation) or symbol-level processing block, non-linear spreading may be achieved. The spreading may be sparse spreading or non-sparse spreading. In sparse spreading, spreading involves zero symbol (a symbol “0” with zero power). For example, symbol s1 sparse spread by sparse sequence [1, 0] produces symbol sequence [s1, 0]. Sparse spreading may also refer to as sparse mapping. Sparse mapping may be done in the symbol-level processing block 348 or the resource mapping block 352.

The symbol-level processing block 348 may embed a device-based or group based signature (fully or partially) to the output sequence of symbols. The operations may be controlled or configured by the input control signaling i₃. For example, one value of i₃ indicates that symbol-level processing block 348 performs no additional operations to the output of bits-to-symbol mapping block 346, another value of i₃ indicates that symbol-level processing block 348 performs multi-dimensional modulation or non-linear spreading, yet another value of i₃ indicates that symbol-level processing block 348 performs linear spreading, yet another value of i₃ indicates that symbol-level processing block 348 performs sparse spreading/sparse mapping etc. As those skilled in the art will appreciate, similar effect/outcome in the output may be achieved through multiple blocks, for example non-linear spreading may be performed by bits-to-symbol mapping block 346 or symbol-level processing block 348 or by the combination of bit-level-processing block 344 and bits-to-symbol mapping block 346.

The symbol-level processing may be scrambling operation. For example, symbol sequence [s1, s2] scrambled by scrambling sequence [1, −1] produces the symbol sequence [s1, −s2]. Symbols may be multiplied by a cover code, that is, symbol sequence [s1, s2] multiplied by [1, −1] to produce the symbol sequence [s1, −s2]. Other symbol-domain operations such as symbol interleaving may be performed (changing the location of the symbols, symbol permutation). In case that specific symbol-level operations are not required (for example, bit-to-symbol mapping block 346 performing spreading), the symbol-level processing block 348 is removed and the output of bit-to-symbol mapping block 346 is directly connected to the subsequent block.

The symbol-level processing block 348 or bit-to-symbol mapping block 346 may embed the device-based signature (in its entirety or in part) to the output symbol sequence. For example, symbol sequence may be linearly spread by a spreading sequence that is unique to the transmitter or UE by the symbol-level processing block 348, and such an operation embeds a device-based signature (in its entirety or in part) to the output symbol sequence. The symbol-level processing block 348 or bit-to-symbol mapping block 346 may embed the group-based signature to the output symbol sequence (in its entirety or in part). For example, symbol sequence may be symbol-scrambled by a scrambling sequence that is unique to the transmitter or UE by the symbol-level processing block 348, such an operation embeds the group-based signature (in its entirety or in part) to the output symbol sequence.

As those skilled in the art will appreciate, spreading, scrambling, permutation, interleaving and similar symbol-level operations may mathematically be represented by matrix operations. For example, symbol sequence [s1, s2] scrambled by scrambling sequence [1, −1] to produce the symbol sequence [s1, −s2] may be written as follows:

$$( \begin{matrix}1 & 0 \\ 0 & - 1\end{matrix} ) ( \begin{matrix}s 1 \\ s 2\end{matrix} ) .$$

As a result, the operations of the symbol-level processing block 348 may be described in different manner for convenience and notations.

The transform precoding block 350 optionally performs precoding such as the discrete Fourier transform (DFT) or others. For example, to achieve a low peak-to-average power ratio (PAPR), symbols are DFT-spread (for example, DFT-spread orthogonal frequency-division multiplexing (DFT-s-OFDM)) and such operations are performed by the transform precoding block 350. As those skilled in the art will appreciate, the transform precoding block 350 may also be located in the process 340 after the resource mapping block 352. The operations of the transform precoding block 350 may be controlled or configured by the input control signaling i₄. For example, one value of i₄ indicates that transform precoding block 350 performs no additional operations to the output of symbol-level processing block 348, another value of i₄ indicates that transform precoding block 350 performs DFT spreading, yet another value of i₄ indicates that transform precoding block 350 performs some waveform related operations on the signal etc. As those skilled in the art will appreciate, the transform precoding block 350 is optional which means that the output of symbol-level processing block 348 is directly connected to the Resource mapping block 352. As those who skilled in the art will appreciate, the transform precoding block 350 may not performs any operations related to the device-based or group-based signature but useful to achieve some useful properties of the generated wireless signal such as low-PAPR, low cubic metric etc.

The output of the transform precoding block 350 or symbol-level processing block 348 (in case the transform precoding block 350 does not exist) is passed to the resource mapping block 352 which may map the symbols to the physical resources (for example, orthogonal frequency-division multiplexing (OFDM) resources grid in NR). The resource mapping block 352 may perform operations such as sparse spreading, puncturing, and/or the like. The output of the resource mapping block 352 comprises or embeds the device-based signature or the group-based signature or both, and the NoMA signal is produced and transmitted from the transmitter side. There may be other operational blocks in the transmit chain such as amplifier, digital-to-analog converter (DAC), up-conversion, waveform-related operations, which are omitted in the simplified block diagram shown in FIG. 10.

The operations of the resource mapping block 352 may be controlled or configured by the input control signaling is. For example, one value of i₅ indicates that resource mapping block 352 performs mapping of symbols to the resource grid (For example, the OFDM resource grid in NR) first in frequency domain and then in time domain, another value of i₅ indicates that the resource mapping block 352 performs mapping of symbols to the resource grid first in time domain and then in time domain, another value of i₅ indicates that the resource mapping block 352 performs symbol mapping non-sparse manner, yet another value of i₅ indicates that the resource mapping block 352 performs sparse symbol mapping according to a given sparse pattern, yet another value of i₅ indicates that the resource mapping block 352 performs non-sparse symbol mapping and symbol puncturing according to a given puncture pattern, yet another value of i₅ indicates that the resource mapping block 352 performs symbol mapping according to a COMB structure (For example, mapping into equally spaced subcarriers in OFDM resource grid using transmission comb number as in 3GPP TS 38.211 V17.0.0 (2021-12)), yet another value of i₅ indicates that the resource mapping block 352 performs symbol mapping in sparse manner and first in frequency domain and then in time domain etc.

By configuring the blocks 342 to 352 by input controls i₁-i₅, the NoMA signal is generated which comprises the device-based signature and/or the group-based signature. As described, each of the blocks 342 to 352 may perform an operation to collectively generate the NoMA signal. As those skilled in the art will appreciate, certain block configurations may achieve specific way of implementation of the device-based signature or group-based signature such as:
The bit-level processing block 346 performing bit-scrambling for a group of transmitters (such as all UEs in a beam or several beams) as a group-based signature to randomize the inter-beam interference, and the bit-to-symbol mapping block 346 performing legacy modulation.
The bit-to-symbol mapping block 346 performing non-linear spreading and the symbol-level processing block 348 performing sparse mapping (non-linear spreading and sparse mapping together defining a device-based signature) and the symbol-level processing 348 performing symbol scrambling as a group-based signature to randomize the inter-beam interference.
The bit-to-symbol mapping block 346 performing non-linear spreading and the symbol-level processing block 348 performing sparse mapping (non-linear spreading and sparse mapping together defining a device-based signature) and the bit-level processing block 344 performing bit scrambling as a group-based signature to randomize the inter-beam interference.
The bit-level processing block 344 performing bit-interleaving and the bit-to-symbol mapping block 346 performing legacy modulation and the symbol-level processing block 348 performing sparse mapping (interleaving and sparse mapping together defining a device-based signature) and the symbol-level processing block 348 performing symbol scrambling as a group-based signature to randomize the inter-beam interference.
Coded bits connected to the bit-to-symbol mapping block 346 and the bit-to-symbol mapping block 346 performing legacy modulation and the symbol-level processing block 348 performing sparse mapping (sparse mapping defining a device-based signature) and the symbol-level processing block 348 performing symbol scrambling as a group-based signature to randomize the inter-beam interference.
The bit-level processing block 344 performing bit-scrambling and as a group-based signature to randomize the inter-beam interference and the bit-to-symbol mapping block 346 performing legacy modulation and the symbol-level processing block 348 performing sparse mapping (sparse mapping defining a device-based signature).
The bit-level processing block 344 performing bit-scrambling as a group-based signature to randomize the inter-beam interference and the bit-to-symbol mapping block 346 performing legacy modulation and the symbol-level processing block 348 performing symbol spreading (where symbol spreading defines the device-based signature).
The bit-level processing block 344 performing bit-scrambling as a group-based signature to randomize the inter-beam interference and the bit-to-symbol mapping block 346 performing legacy modulation and the symbol-level processing block 348 performing symbol spreading and symbol-level scrambling (where symbol spreading and scrambling together defining a device-based signature).
The bit-level processing block 344 performing bit-scrambling as a group-based signature to randomize the inter-beam interference and the bit-to-symbol mapping block 346 performing legacy modulation and the symbol-level processing block 348 performing symbol spreading and symbol sparse-mapping (where symbol spreading and sparse mapping together defining a device-based signature).

In some embodiments, the group-based NoMA signal generation may be enabled and disabled via suitable configurations and/or control inputs (for example, by using i₁ to i₅ in FIG. 10 or by using other suitable methods). When group-based NoMA signal generation is enabled, the group-based signature is used in NoMA signal generation. When group-based NoMA signal generation is disabled, the group-based signature is not used in NoMA signal generation (that is, generating the NoMA signal using conventional methods). Similarly, in some embodiments, the group-based reference signal generation may be enabled and disabled via suitable configurations and/or control inputs.

As those skilled in the art will appreciate, the block diagram shown in FIG. 10 may produce a NoMA signal that consisting of the device-based signature and/or the group-based signature. For example, the transmitter may be configured to transmit a NoMA signal with a group-based signature but without a transmitter-specific device-based signature embedded into the signal. This is useful when the interference level between beams or beam-groups is high (which however may be mitigated by the use of a group-based signature) but intra-beam interference is low (which may otherwise be mitigated by other means). On the other hand, the transmitter may be configured to transmit a NoMA signal with a transmitter-specific device-based signature embedded into the signal but without a group-based signature. This is useful when intra-beam interference is high (which however may be mitigated by the use of the device-based signature) but the interference level between beams or beam-groups is low (which may otherwise be mitigated by other means). For example, the input controls i₁-i₅ may be appropriately configured to produce a signal which consists of device-based signature only or group-based signature only or both device-based signature and group-based signature.

In some embodiments, the above-described transmitter grouping and group-based signature may be used for generating group-based reference signals.

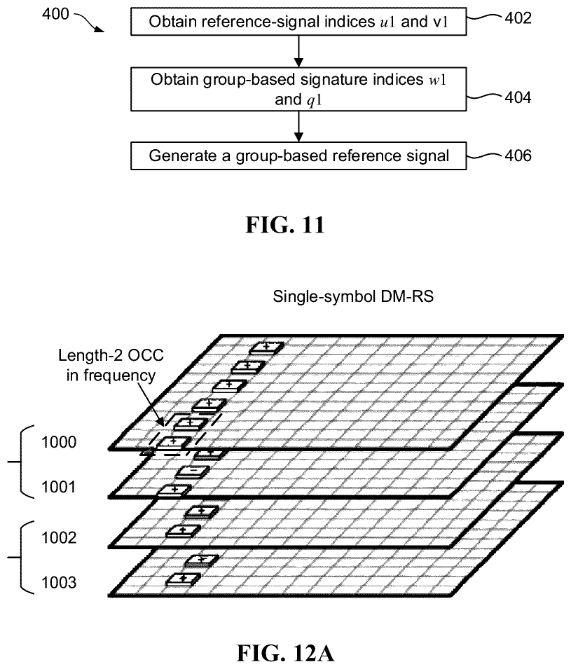

FIG. 11 is a flowchart showing a process 400 for generating a group-based reference signal for the q1-th beam/UE group (K−1≥q1≥0) of the K beam/UE groups after the beams/UEs have been classified into the K groups based on the inter-beam/inter-group interference as described above.

In these embodiments, a plurality of reference-signal pools are provided. Each reference-signal pool comprises a plurality of reference signals (denoted “device-based reference signals” for differentiating from conventional reference signals and the group-based reference signals) such as conventional (NR specification supported) reference signals. For example, a reference-signal pool having a plurality of U (U≥1 is an integer) reference-signal pools D⁽⁰⁾, D⁽¹⁾, . . . , D^{(U-1)} may be used. Each reference-signal pool D^{(u)} (U−1≥u≥0) has V device-based reference signals d₀^{(u)}, d₁^{(u)}, . . . , d_{V-1}^{(u)}. In some embodiments, the plurality of device-based reference signals may be mutually orthogonal to each other. However, in some other embodiments, the device-based reference signals may not be mutually orthogonal to each other as along as they may be successfully determined from the interferences and noises.

At step 402, a reference-signal pool index u1 (U−1≥u1≥0) is obtained, for example, by selecting or otherwise obtaining a reference-signal pool, and a reference-signal index v1 (V−1≥v1≥0) is obtained, for example, by selecting or otherwise obtaining a reference-signal dᵥ₁^{(u1)} from the selected reference-signal pool.

In these embodiments, a plurality of group-based signature pools are provided. Each group-based signature pool comprises a plurality of group-based signatures. At step 404, a group-based signature pool index w1 is selected for the beam/UE groups, and a group-based signature index is selected as q1. By using the indices w1 and q1, a group-based signature h_{q1}^{(w1)} is obtained or otherwise obtained from the selected group-based signature pool.

At step 406, the group-based reference signal for the q1-th beam/UE group is obtained as:

$$r = {h}_{q 1}^{( w 1 )} {d}_{v 1}^{( u 1 )} . \qquad ( 10 )$$

In some embodiments, a plurality of group-based signatures may be applied to a device-based reference signal. For example, a group-based reference signal r may be obtained by cascaded operations that apply two group-based signatures h₁ and h₂ to a device-based reference signal d (that is r=h₂ h₁ d). The h₂ h₁ may be considered and implemented as a single group-based signature comprising two operations defined by h₂ and h₁.

In one example, h₁ may adjust the phase of the device-based reference signal d and h₂ may adjust the amplitude of h₁ d. In another example, h₁ may adjust the phase of the device-based reference signal d for long-term phase/channel variations and h₂ may adjust the phase of h₁ d for short-term phase/channel variations. In these examples, d may represent a device-based reference signal or a device-based reference signal sequence such as Pseudo-Noise (PN) sequence, Zadoff-Chu (ZC) sequence, computer-generated sequences, low-PAPR sequence, and/or the like. For example, d may be a DM-RS generated according to for example, 5G NR specification as per 3GPP TS 38.211 V17.0.0 (2021-12) and one or more group-based signatures are applied on d. In another example, d may be a low-PAPR sequence and one or more group-based signatures (for example, symbol scrambling, spreading, and/or the like) are applied to d. In addition to one or more group-based signatures, other operations may be performed on device-based reference signals such as power adjustment, scaling, control, and/or the like.

In various embodiments, the group-based reference signal generation process 400 may be used for generating group-based SRS, CSI-RS, PT-RS, SSB, PSS, SSS, preamble transmission (for example, the 2-step or 4-step RACH process, or the like), or other downlink or uplink reference signals.

Those skilled in the art will appreciate that the group-based reference signal and the NoMA signal generated using the group-based signature may be used together or separately. For example, the NoMA signal generated using the group-based signature may be used together with the conventional DM-RS signal (such as that defined in 5G NR). Alternatively, the physical uplink shared channel (PUSCH), the physical downlink shared channel (PDSCH), the physical uplink control channel (PUCCH), or physical downlink control channel (PDCCH) signal may be generated using the group-based reference signal generation process 400 described above.

Those skilled in the art will appreciate that, in various embodiments, the group-based signature pool used for generating the group-based signature may or may not be the same as the group-based signature pool used for generating the group-based reference signal. In various embodiments, the group-based reference signals may substitute conventional reference signals. On the other hands, many conventional or legacy reference signals may be used as the device-based reference signals for generating the group-based reference signals. As an example, NR standard defined reference signals, for example DM-RS, preamble, SRS, CSI-RS, PTRS, PSS, SSS, SSB in 3GPP TS 38.211 V17.0.0 (2021-12) may be referred as conventional or legacy reference signals.

In NR, reference signals are predefined signals (for example, predefined as described above) occupying specific resource elements within the time-frequency grid. The NR specification includes several types of reference signals transmitted in different ways and intended to be used for different purposes by a receiving device.

The NR reference signals include:
Demodulation reference signals (DM-RS) for PDSCH (downlink data), which are intended for channel estimation at the device as part of coherent demodulation. They are present only in the resource blocks used for PDSCH transmission. Similarly, the DM-RS for PUSCH allows the BS to coherently demodulate the PUSCH (uplink data).
DM-RS, which is also used in PDCCH (commonly referred as control channel) and PBCH (commonly referred as broadcast channel).
Phase-tracking reference signals (PT-RS), which may be seen as an extension to DM-RS for PDSCH/PUSCH and are intended for phase-noise compensation. The PT-RS is denser in time but sparser in frequency than the DM-RS, and, if configured, occurs only in combination with DM-RS (in NR).
CSI reference signals (CSI-RS), which are downlink reference signals intended to be used by devices to acquire downlink channel-state information (CSI). Specific instances of CSI reference signals can be configured for time/frequency tracking and mobility measurements.
Tracking reference signals (TRS) are sparse reference signals intended to assist the device in time and frequency tracking. A specific CSI-RS configuration serves the purpose of a TRS in NR.
Sounding reference signals (SRS) are uplink reference signals transmitted by the devices and used for uplink channel-state estimation at the base stations.

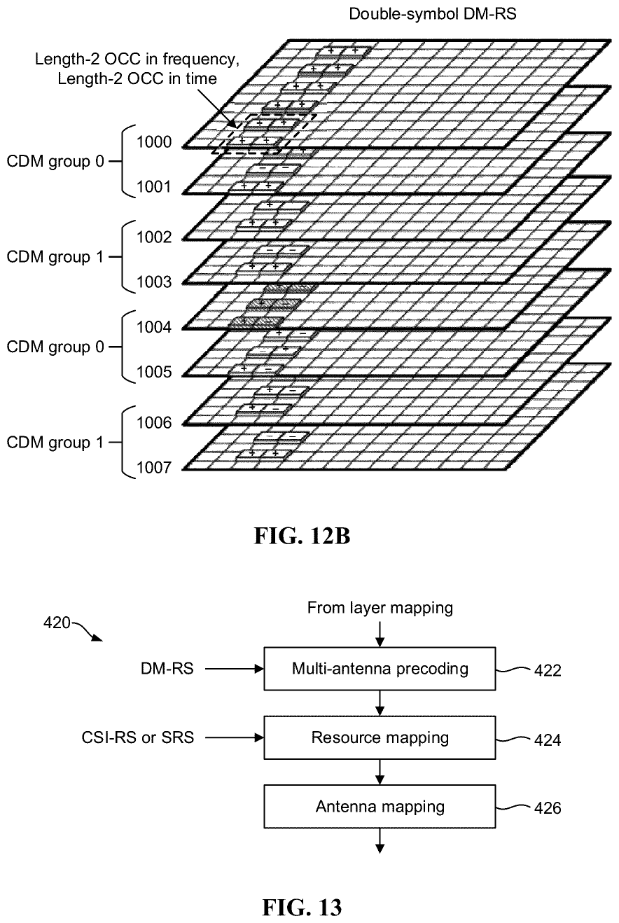

Example of DM-RS are shown in FIGS. 12A and 12B. As shown, DM-RS may be a single symbol or multiple symbols in time domain and mapped in frequency domain in sparse manner. This is commonly referred as a comb structure. Alternatively, symbols may be mapped non-sparse manner in frequency domain as well. In the example shown from NR, antenna ports 1000 and 1001 use even-numbered subcarriers in the frequency domain and are separated from each other by multiplying the underlying pseudo-random sequence with different length-two orthogonal sequences in the frequency domain, resulting in transmission of two orthogonal reference signals for the two antenna ports. As long as the radio channel is flat across four consecutive subcarriers, the two reference signals will be orthogonal also at the receiver. Antenna ports 1000 and 1001 are said to belong to Code Division Multiplexing (CDM) group 0 as they use the same subcarriers but are separated in the code-domain using different orthogonal sequences. Reference signals for antenna ports 1002 and 1003 belong to CDM group 1 and are generated in the same way using odd-numbered subcarriers, that is, separated in the code domain within the CDM group and in the frequency domain between CDM groups. If more than four orthogonal antenna ports are needed, two consecutive OFDM symbols are used instead. The structure above is used in each of the OFDM symbols and a length-2 orthogonal sequence is used to extend the code domain separation to also include the time domain, resulting in up to eight orthogonal sequences in total. This may be considered as a DM-RS pool.

By increasing the number of supported sequences or CDM groups, COMB structure in mapping, varying number of DM-RS sequences may be defined. Therefore, it is possible to support different size of DM-RS pools suitable for various application scenarios.

The reference signals are supported for multiple waveforms such as CP-OFDM, DFT-s-OFDM, and the like.

The sequences used for reference signal may be ZC sequence, pseudo-random sequences or computer-generated sequences, and/or the like. Smaller power variation, good autocorrelation properties, low cubic metric (CM), low PAPR, ability to have sufficient number of sequences for a given length may be considered as some of the useful properties of a good reference signal sequence.

Similar to DM-RS, other reference signal sequences and corresponding group-based signature pools may be defined. NR standard defines preamble, SRS, CSI-RS, PTRS, PSS, SSS, SSB structure and their time-frequency domain mapping along with the sequences to be used for different lengths. Such sequences with embedded group-based signatures may be obtained in a manner similar to that described above.

In a legacy multi-antenna transmit chain (uplink, downlink, sidelink, or the like), coded bits sequence may be modulated by a legacy modulator to obtain modulated symbol sequence. In a multi-antenna transmission, modulated symbols are transmitted over multiple transmission layers (commonly known as layer mapping). In an alternative approach, the output of the symbol-level processing may be mapped to multiple layers. In yet another approach, the output of the coded bits or bit-level processing or information bits are split into multiple bit-streams (for example, using a demultiplexer (DEMUX) block) and subsequent bit-level processing or symbol-level processing or bit-to-symbol mapping are performed on each bit-stream separately and may be mapped to layers.

After layer mapping, transform precoding may optionally be performed. As described earlier, transform precoding is especially useful in uplink transmission to achieve low-PAPR or CM. The layer-mapped symbols are passed to a multi-antenna precoding block. The output of the multi-antenna precoding block is then input to resource mapping block. The resource mapping block output is input to physical antenna and other blocks in the transmission chain for further signal processing and generating a transmitting signal to be transmitted by a transmitter.

FIG. 13 shows an example of downlink transmission 420. After the layer mapping, the DM-RS is multiplexed along with data symbols and passed to the multi-antenna precoding block 422. As DM-RS is a sequence of symbols and may be generated as described in 3GPP TS 38.211 V17.0.0 (2021-12) or in other methods described before. The DM-RS sequence may be scrambled or apply a cover code in a beam-specific manner or beam-group specific manner so that the neighboring beam or beam-groups interference is randomized.

The sequence-level processing may be scrambling operation. For example, sequence [s1, s2] scrambled by scrambling sequence [1, −1] produces the symbol sequence [s1, −s2] before mapping to the DM-RS symbols in the resource grid. Symbols may be multiplied by a cover code, that is, symbol sequence [s1, s2] multiplied by [1, −1] to produce the symbol sequence [s1, −s2]. Other symbol domain operations such as symbol interleaving may be performed (changing the location of the symbols, symbol permutation, and/or the like).

Other operations such as DM-RS sequence generation may be used. For example, when the DM-RS sequence such as ZC sequence, different roots or different cyclic shifts of the sequence or different lengths or other parameters may be used. As described in 3GPP TS 38.211 V17.0.0 (2021-12), sequence hopping, group hopping or other methods may be used. Such operations or manner in which the DM-RS sequence generated in a beam-specific or beam-group specific or transmitter group specific manner so that inter-beam interference is randomized. Such techniques may be employed for embedding group-based signatures.

The output of the multi-antenna precoding block 422 is then passed to the resource mapping block 424. Then, CSI-RS (downlink transmission) or SRS (in uplink) transmission may be mapped (if configured). In a similar manner to DM-RS, CSI-RS, and SRS, symbol sequences may also be generated with a beam-specific or beam-group specific or transmitter-group specific manner so that inter-beam interference is randomized. Therefore, such techniques may be employed for embedding group-based signatures. The root or cyclic shifts/rotations or applying a cover code or symbol scrambling or sequence hopping, group hopping as described in 3GPP TS 38.211 V17.0.0 (2021-12) and methods may also be employed for embedding group-based signatures.

Similar approaches may be used for other reference-signal transmission such as PT-RS, TRS, and the like. The preamble transmission used for random access (CBRA/CFRA), 2-step/4-step RACH is a symbol sequence and may use the methods described above. As described, SSB comprises PSS, SSS, and PBCH, wherein PSS and SSS are sequences and PBCH contains information carrying modulated symbols. Therefore, PSS and SSS may use the group-based signature methods described above for sequences while PBCH may use the techniques described above for group-based signatures or device-based signatures or both. As such, a skilled person in the art may apply the methods disclosed herein for different reference signal sequences or data transmission.

As those skilled in the art will appreciate, applying group-based signatures to a device-based reference signal is different than applying group-based signatures to a NoMA signal. As mentioned earlier, device-based reference signals may be used for estimating or measuring properties or features of the wireless links while the NoMA signals carry information bits to be decoded/detected at the receiver side. Therefore, when the group-based signature is used in the device-based reference signal, the group-based signature helps the measurement/estimation process while the group-based signature helps detection/decoding when it is applied to NoMA signals. As a result the group-based signature suitable/appropriate for a device-based reference signal may be different from the group-based signature suitable/appropriate for NoMA signal. Another difference is that group-based signature may be applied in bit domain (through bit-level processing) for NoMA signals (for example, as shown in FIG. 10 and related descriptions) while in generation of the group-based reference signals, usually there does not exist a bit domain implementation of group-based signature (for example, as shown in FIG. 13 and related descriptions).

Different transmitters may use orthogonal resources (or orthogonal ports) for separating the sequences from different reference-signal transmissions. Such orthogonality may be achieved by a cover code, by using orthogonal resources or orthogonal sequences in order to avoid interference from other layers of the same transmitter or different transmitters. The group-based signature may be applied on top of such operations in a beam-specific, beam-group specific or transmitter group (that is, a group of transmitters or a group of UEs) specific manner to achieve inter-beam interference randomization. The group-based signature may be applied to CDM group in a specific manner. For example, a first group of UEs using a first CDM group may use a first group-based signature and a second group of UEs using the first CDM group may use a second group-based signature. Group-based signatures may also be used to achieve intra-beam interference randomization between multiple transmitters using the same beam (inter-user/inter-transmitter interference) in reference-signal transmission.

In some embodiments, the above-described indices obtained at one side (for example, the transmitter side or the receiver side) using the process 300 and/or 400 may be transmitted, indicated, or signaled to the other side (for example, the receiver side or the transmitter side). The transmitter side may use such received, signaled, indicated, or derived information to generate NoMA signals (for example, using the process 340). The receiver side may use such received, signaled, indicated, or derived information to decode the NoMA signal and/or the group-based reference signal received from the transmitter side.

By configuring the input controls of DM-RS generation in 420 or multi-antenna precoding 422 or CSI-RS or SRS generation in 420 or resource mapping 424, the group-based reference signal may be generated. The input controls configure the group-based signature or device-based signature for generation of the group-based reference signal. In a similar manner, input controls may be used to generate other reference signals such as preamble, PTRS, PSS, SSS, SSB, and the like.

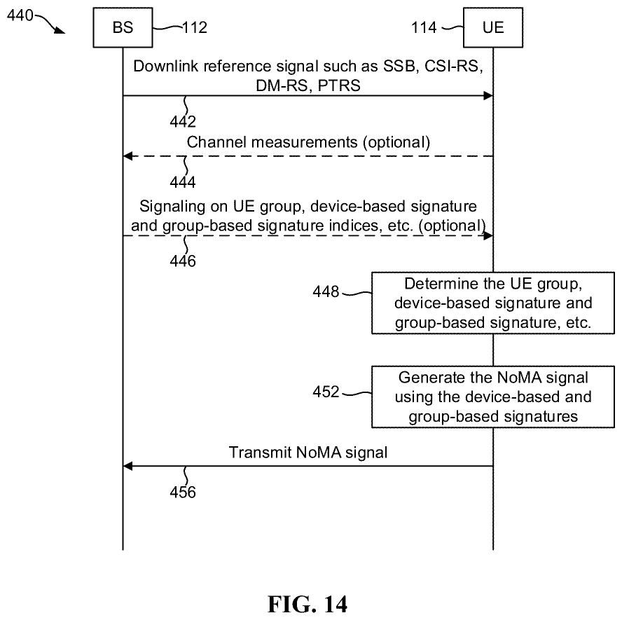

FIG. 14 is a signaling diagram 440 showing an uplink data transmission between a UE 114 and a base station 112 using NoMA signals embedded with device-based and group-based signatures (also denoted “group-based NoMA signals”).

As shown, the base station 112 transmits one or more downlink reference signals 442 which may include SSB, CSI-RS, DM-RS, PT-RS, and/or the like to the UE 114. The reference signals 442 may be conventional reference signals without combining the group-based signature (for example, at an initial stage when the group-based signature has not been generated), or may be group-based reference signals generated with the combination of the group-based signature (for example, at a later stage when the group-based signature has been generated).

After receiving the reference signals 442, the UE 114 performs channel measurements, and reports the measured channel conditions (that is, the communication conditions) 444 to the base station 112, for example, via uplink control information (UCI).

The base station 112 collects the measured communication conditions from a plurality of UEs 114 and classifies the UEs 114 into one or more UE groups or beam groups based on the collected communication conditions as described above. Then, the base station 112 determines the indices of the device-based signature and the group-based signature as described above, and transmits to UEs in each UE group a control signal 446 having for example, the UE group identity (ID), the indices l1 and p1 of the device-based signature, the indices m1 and k1 of the group-based signature, and other information as needed, via, for example, RRC, downlink control information (DCI), medium access control layer (MAC) control element (MAC-CE), RRC-release message, Random access response (RAR), and/or the like.

The UE 114 maintains a copy of the device-based signature pools and the group-based signature pools (which may be received from the base station 112 via, for example, RRC, downlink control information (DCI) or uplink control information (UCI), medium access control layer (MAC) control element (MAC-CE), and/or the like). After the UE 114 receives the control signal 446, the UE 114 determines the UE group, the device-based signature (using the device-based signature indices), the group-based signature (using the group-based signature indices), and other information (block 448). Then, the UE 114 generates the group-based NoMA signal using the device-based and group-based signatures as described above and may also generate other necessary information (such as modulation, waveform, physical resource, and/or the like) (block 452). The UE 114 then transmits the group-based NoMA signal 456 to the base station 112.

In some embodiments, the UE 114 may not perform and/or report channel measurements and therefore may not send channel measurements 444 to the base station 112. For example, the UE 114 may be allowed by the base station 112 to use a particular pool if the measured signal is above a certain threshold, reporting channel measurements may not be required. Similarly, the base station 112 may not send signaling 446 on UE group, device-based signature and group-based signature indices, and/or the like to the UE 114.

In these embodiments, the UE 114 may determine its group-based signature without signaling. For example, as SSB has one-to-one mapping to the beam, the UE 114 may use the beam ID (that is, the SSB number) to obtain the group-based signature.

In these embodiments, the base station 112 may use various methods to determine the device-based signature in the signals received from the UE 114. For example, in some embodiments, before decoding data, the base station 112 may perform detection of the device-based signature. In some other embodiments, the device-based signature is mapped to DM-RS or other reference signal (transmitted along with NoMA signal carrying data). Thus, the base station 112 may determine the device-based signature from the DM-RS or other reference signals.

In some embodiments, the base station 112 may use the group-based signature to generate a group-based reference signal as described above for the UEs of each UE group for the next round of channel estimation.

In some embodiments, the base station 112 does not transmit the device-based signature indices l1 and p1 in the control signal 446. Rather, the base station 112 may transmits the device-based signature pool index l1 and allow the UE 114 to randomly select a device-based signature from the device-based signature pool S).

In some embodiments, the base station 112 does not transmit the device-based signature indices l1 and p1 in the control signal 446. Rather, the base station 112 allows the UE 114 to randomly select a device-based signature from the plurality of device-based signature pools.

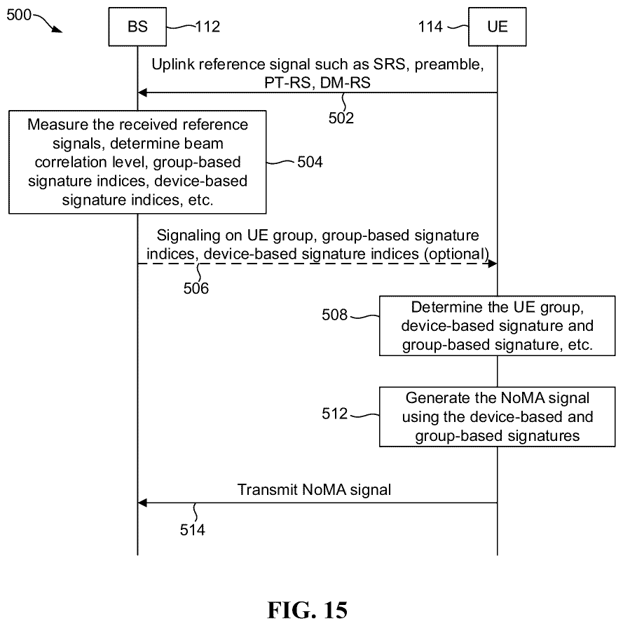

In some embodiments as shown in FIG. 15, the communication conditions may be measured by the base station 112. As shown, the UE 114 may transmit one or more uplink reference signals 502 such as SRS, preamble transmission, PT-RS, DM-RS, and/or the like to the base station 112.

The base station 112 receives the reference signals 502 from a plurality of UEs 114 and performs channel measurements, including measuring the received reference signals, determining beam correlation levels, determining group-based signature indices and/or device-based signature indices, and/or the like (block 504) for each UE 114. The base station 112 classifies the UEs 114 into one or more UE groups or beam groups based on the measured communication conditions as described above. Then, the base station 112 determines the device-based signature and group-based signature indices as described above, and transmits to UEs in each UE group a control signal 506 having for example, the UE group ID, the indices l1 and p1 of the device-based signature, the indices m1 and k1 of the group-based signature, and other information as needed.

The UE 114 maintains a copy of the device-based signature pools and the group-based signature pools. UE may generate the device-based signature pools or the group-based signature pools or both using redefined formula or other suitable methods. After the UE 114 receives the control signal 506, the UE 114 determines the UE group, the device-based signature (using the device-based signature indices), the group-based signature (using the group-based signature indices), and other information (block 508).

Then, the UE 114 generates the NoMA signal using the device-based signature and group-based signature as described above and other necessary information (such as modulation, waveform, physical resource, and/or the like) (block 512). The UE 114 then transmits the NoMA signal 514 to the base station 112.

In some embodiments, the UE 114 may use the group-based signature to generate a group-based reference signal as described above.

In some embodiments, only one device-based signature pool is used. In these embodiments, the base station 112 only transmits the device-based signature index in the device-based signature pool to the UE 114.

In some embodiments, only one group-based signature pool is used. In these embodiments, the base station 112 only transmits the group-based signature index in the group-based signature pool to the UE 114.

Similar to the examples shown in FIGS. 14 and 15, downlink NoMA signals may be generated using the device-based and group-based signatures as described above, and uplink reference signals may be group-based reference signals generated as described above. Of course, in some embodiments, the uplink reference signals may be conventional reference signals without combining with the group-based signatures as described above.

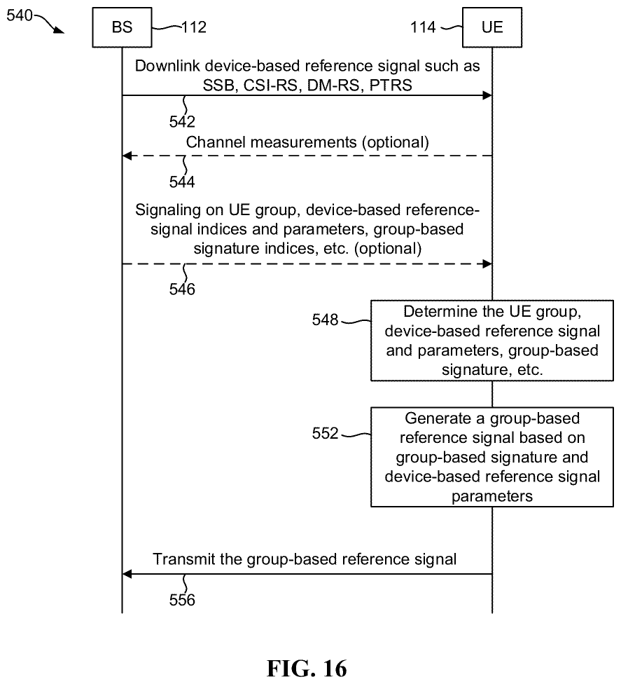

FIG. 16 is a signaling diagram 540 showing an uplink transmission of a group-based reference signal from a UE 114 to a base station 112, according to some embodiments of this disclosure. The group-based reference signal combines a device-based reference signal and a group-based signature.

As shown, the base station 112 transmits one or more downlink initial reference signals 542 which may include SSB, CSI-RS, DM-RS, PT-RS, and/or the like to the UE 114. The initial reference signals 542 may be conventional reference signals without combining the group-based signature (for example, at an initial stage when the group-based signature has not been generated), or may be group-based reference signals generated with the combination of the group-based signature (for example, at a later stage when the group-based signature has been generated).

After receiving the initial reference signals 542, the UE 114 performs channel measurements, and reports the measured channel conditions (that is, the communication conditions) 544 to the base station 112, for example, via uplink control information (UCI).

The base station 112 collects the measured communication conditions from a plurality of UEs 114 and classifies the UEs 114 into one or more UE groups or beam groups based on the collected communication conditions as described above. Then, the base station 112 determines the indices of the device-based reference signal and the group-based signature as described above, and transmits to UEs in each UE group a control signal 546 having for example, the UE group identity (ID), device-based reference signal parameters including the indices l1 and p1 of the device-based reference signal, the indices m1 and k1 of the group-based signature, and other information as needed, via, for example, RRC, downlink control information (DCI), medium access control layer (MAC) control element (MAC-CE), RRC-release message, Random access response (RAR), and/or the like.

The UE 114 maintains a copy of the device-based reference-signal pools and the group-based signature pools (which may be received from the base station 112 via, for example, RRC, downlink control information (DCI) or uplink control information (UCI), medium access control layer (MAC) control element (MAC-CE), and/or the like). After the UE 114 receives the control signal 546, the UE 114 determines the UE group, the device-based reference signal (using the device-based reference-signal indices) and relevant parameters, the group-based signature (using the group-based signature indices), and other information (block 548). Then, the UE 114 generates the group-based NoMA signal using the reference signal and the group-based signature as described above (block 552). The UE 114 then transmits the group-based reference signal 556 to the base station 112.

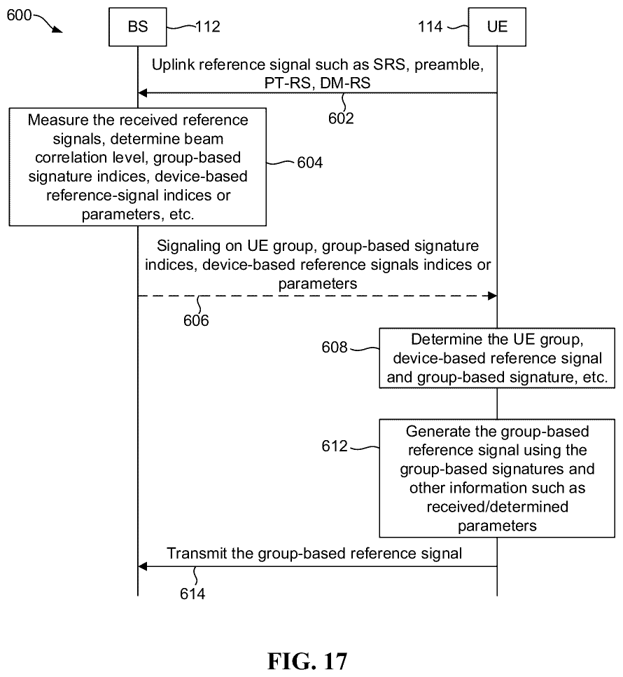

In some embodiments as shown in FIG. 17, the communication conditions may be measured by the base station 112. As shown, the UE 114 may transmit one or more uplink initial reference signals 602 such as SRS, preamble transmission, PT-RS, DM-RS, and/or the like to the base station 112.

The base station 112 receives the initial reference signals 602 from a plurality of UEs 114 and performs channel measurements, including measuring the received initial reference signals, determining beam correlation levels, determining the group-based signature indices and device-based reference-signal indices or parameters, and/or the like (block 604). More specifically, the base station 112 classifies the UEs 114 into one or more UE groups or beam groups based on the measured communication conditions as described above. Then, the base station 112 determines the device-based reference-signal indices and group-based signature indices as described above, and transmits to UEs in each UE group a control signal 606 having for example, the UE group ID, the indices l1 and p1 of the device-based reference signal, the indices m1 and k1 of the group-based signature, and other information as needed.

The UE 114 maintains a copy of the device-based reference-signal pools and the group-based signature pools. UE may generate the device-based reference-signal pools or the group-based signature pools or both using redefined formula or other suitable methods. After the UE 114 receives the control signal 606, the UE 114 determines the UE group, the device-based reference signal (using the device-based reference-signal indices), the group-based signature (using the group-based signature indices), and other information (block 608).

Then, the UE 114 generates the group-based reference signal using the group-based signatures as described above and other information such as received/determined parameters. The UE 114 then transmits the group-based reference signal 614 to the base station 112.

Although FIGS. 14 to 17 describe the transmission from UE side to BS, those skilled in the art may appreciate that similar approach and signaling may facilitate for downlink or sidelink NoMA transmission (with device-based signature and group-based signature) and for downlink or sidelink group-based reference signal transmission (with device-based reference signals and group-based signature).

As described, the receiving of signaling from base station 112 to UE side 114, for example the steps 446, 506, 546, 606 in FIGS. 14 to 17 respectively, may happen through RRC signaling, DCI, MAC-CE, or RRC release message or other signaling methods while the UE is in the RRC-connected or inactive states or other RRC state.

In above embodiments, the device-based and group-based signatures are used for communication between the base station and the UEs (via uplinks and downlinks therebetween). In some embodiments, the device-based and group-based signatures may be used for communication between UEs via sidelinks therebetween.

In above embodiments, the device-based and group-based signatures are used for generating the NoMA signals. In some embodiments, the generation of the NoMA signals may only use the group-based signature and may not use any device-based signature.

In above embodiments, the wireless signals transmitted between the base station 112 and UEs 114 and between different UEs 114 are NoMA signals. In some embodiments, the wireless signals transmitted between the base station 112 and UEs 114 and between different UEs 114 may be other suitable wireless signals (for example, OFDM signals) embedded with the group-based and/or device-based signatures.

In above embodiments, the grouping of UEs 114 is based on the beam grouping. In some embodiments, the UEs 114 may be grouped using other suitable criteria.

In the embodiments shown in FIG. 10, the blocks 344 to 352 each having a respective control input i₁ to i₅. In some embodiments, only a subset of the blocks 344 to 352 have their respective control inputs. In some other embodiments, none of the blocks 344 to 352 have control inputs.

The device-based and group-based signatures and the generation methods thereof disclosed herein provide several advantages such as:
Providing a unified solution to effectively mitigate the varying level of inter-beam and intra-beam interference originated from beam/channel correlations, UE traffic, TBS, RRC states, and/or the like;
Exploiting the beam channel diversity for effectively separating the transmission and for supporting a large number of UEs within a cell;
Providing implicitly or explicitly signaling-based beam/UE grouping based on long-term statistics such as channel correlation properties, UE traffic, TBS, and/or the like;
Effectively adapting to various number of randomly active UEs in grant-free transmissions and grant-based transmissions;
Providing intra-beam interference mitigation with UE separation for UEs within a beam by controlling the parameters of the device-based signature pools such as spreading length, orthogonal device-based signature pools, and/or the like, thereby providing flexibility for varying UE activities within a beam;
Effectively supporting various number of active UEs in a large number of UEs.
Using feasible approaches to measure beam channel correlation and other long-term statistics within for example, the 5G NR framework;
Providing adaptive adjustment to the dynamic/varying channel conditions in beam-based communication systems;
Intra-beam and inter-beam channel-correlation measurements may be conducted by using one or more of conventional reference signals such as SRS, CSI-RS, SSB, preamble transmission, PT-RS, and/or the like;
Providing a unified framework for various NoMA technologies (for example, those list above);
Suitable for exploiting the advantages of various NoMA technologies;
Providing highly flexible approaches for standardization and agreement;
Easy to integrate with 5G NR 2-step RACH based data transmission;
Consistent with consecutive N-beam based resource allocation (that is, RACH occasion and PUSCH occasion) and 5G NR framework.

Although embodiments have been described above with reference to the accompanying drawings, those of skill in the art will appreciate that variations and modifications may be made without departing from the scope thereof as defined by the appended claims.

1. A method comprising:
obtaining a first signature for a group comprising a user equipment (UE);
obtaining a second signature for the UE;
generating a wireless signal based on the first and second signatures; and
transmitting the wireless signal via a physical resource from or to the UE.

2. The method of claim 1, wherein said generating the wireless signal based on the first and second signatures comprises:
generating a bit sequence,
generating a first symbol sequence based on the bit sequence, and
generating the wireless signal based on the first symbol sequence; and
wherein the method further comprises:
modifying the bit sequence and the symbol sequence based on one of the first and second signatures before said generating the first symbol sequence and based on the other of the first and second signatures before said generating the wireless signal, respectively,
modifying the bit sequence based on the first and second signatures before said generating the first symbol sequence, or
modifying the symbol sequence based on the first and second signatures before said generating the wireless signal.

3. The method of claim 1, wherein the second signature comprises F elements s(0), s(1), . . . , s(F−1), where F>1 is an integer;
wherein the first signature comprises F elements c(0), c(1), . . . , c(F−1); and
wherein said generating the wireless signal based on the first and second signatures comprises:
calculating a third signature as c(0)s(0), c(1)s(1), . . . , c(F−1)s(F−1); and
generating a wireless signal based on the third signature.

4. The method of claim 1, wherein said obtaining the second signature comprises:
obtaining at least a first index of the second signature indicating the second signature in a second signature pool comprising a plurality of second signatures; and
obtaining the second signature from the second signature pool using the at least first index of the second signature.

5. The method of claim 1, wherein said obtaining the first signature comprises:
obtaining at least a first index of the first signature indicating the first signature in the first signature pool comprising a plurality of first signatures; and
obtaining the first signature from the first signature pool using the at least first index of the first signature.

6. The method of claim 1 further comprising:
obtaining communication conditions of the physical resource; and
classifying a plurality of UEs using the physical resource for communication into one or more UE groups based on the obtained communication conditions, the plurality of UEs comprising the UE;
wherein said transmitting the wireless signal via the physical resource comprises:
transmitting the wireless signal to the UE via the physical resource; and
wherein said obtaining the first signature comprises:
determining the first signature based on the UE group of the UE.

7. An apparatus for executing instructions to perform actions comprising:
obtaining a first signature for a group comprising a user equipment (UE);
obtaining a second signature for the UE;
generating a wireless signal based on the first and second signatures; and
transmitting the wireless signal via a physical resource from or to the UE.

8. The apparatus of claim 7, wherein said generating the wireless signal based on the first and second signatures comprises:
generating a bit sequence,
generating a first symbol sequence based on the bit sequence, and
generating the wireless signal based on the first symbol sequence; and
wherein the method further comprises:
modifying the bit sequence and the symbol sequence based on one of the first and second signatures before said generating the first symbol sequence and based on the other of the first and second signatures before said generating the wireless signal, respectively,
modifying the bit sequence based on the first and second signatures before said generating the first symbol sequence, or
modifying the symbol sequence based on the first and second signatures before said generating the wireless signal.

9. The apparatus of claim 7, wherein the second signature comprises F elements s(0), s(1), . . . , s(F−1), where F>1 is an integer;
wherein the first signature comprises F elements c(0), c(1), . . . , c(F−1); and
wherein said generating the wireless signal based on the first and second signatures comprises:
calculating a third signature as c(0)s(0), c(1)s(1), . . . , c(F−1)s(F−1); and
generating a wireless signal based on the third signature.

10. The apparatus of claim 7, wherein said obtaining the second signature comprises:
obtaining at least a first index of the second signature indicating the second signature in a second signature pool comprising a plurality of second signatures; and
obtaining the second signature from the second signature pool using the at least first index of the second signature.

11. The apparatus of claim 7, wherein said obtaining the first signature comprises:
obtaining at least a first index of the first signature indicating the first signature in the first signature pool comprising a plurality of first signatures; and
obtaining the first signature from the first signature pool using the at least first index of the first signature.

12. The apparatus of claim 7, wherein the actions further comprise:
obtaining communication conditions of the physical resource; and
classifying a plurality of UEs using the physical resource for communication into one or more UE groups based on the obtained communication conditions, the plurality of UEs comprising the UE;
wherein said transmitting the wireless signal via the physical resource comprises:
transmitting the wireless signal to the UE via the physical resource; and
wherein said obtaining the first signature comprises:
determining the first signature based on the UE group of the UE.

13. A non-transitory computer-readable storage medium comprising computer-executable instructions, wherein the instructions, when executed, cause a processing structure to perform actions comprising:
obtaining a first signature for a group comprising a user equipment (UE);
obtaining a second signature for the UE;
generating a wireless signal based on the first and second signatures; and
transmitting the wireless signal via a physical resource from or to the UE.

14. The non-transitory computer-readable storage medium of claim 13, wherein said generating the wireless signal based on the first and second signatures comprises:
generating a bit sequence,
generating a first symbol sequence based on the bit sequence, and
generating the wireless signal based on the first symbol sequence; and
wherein the method further comprises:
modifying the bit sequence and the symbol sequence based on one of the first and second signatures before said generating the first symbol sequence and based on the other of the first and second signatures before said generating the wireless signal, respectively,
modifying the bit sequence based on the first and second signatures before said generating the first symbol sequence, or
modifying the symbol sequence based on the first and second signatures before said generating the wireless signal.

15. The non-transitory computer-readable storage medium of claim 13, wherein the second signature comprises F elements s(0), s(1), . . . , s(F−1), where F>1 is an integer;
wherein the first signature comprises F elements c(0), c(1), . . . , c(F−1); and
wherein said generating the wireless signal based on the first and second signatures comprises:
calculating a third signature as c(0)s(0), c(1)s(1), . . . , c(F−1)s(F−1); and
generating a wireless signal based on the third signature.

16. The non-transitory computer-readable storage medium of claim 13, wherein said obtaining the second signature comprises:
obtaining at least a first index of the second signature indicating the second signature in a second signature pool comprising a plurality of second signatures; and
obtaining the second signature from the second signature pool using the at least first index of the second signature.

17. The non-transitory computer-readable storage medium of claim 16, wherein the at least first index of the second signature comprises the first index of the second signature and a second index of the second signature indicating the second signature pool in a plurality of second signature pools; and
wherein said obtaining the second signature from the second signature pool using the at least first index of the second signature comprises:
obtaining the second signature pool from the plurality of second signature pools using the second index of the second signature, and
obtaining the second signature from the second signature pool using the first index of the second signature.

18. The non-transitory computer-readable storage medium of claim 13, wherein said obtaining the first signature comprises:
obtaining at least a first index of the first signature indicating the first signature in the first signature pool comprising a plurality of first signatures; and
obtaining the first signature from the first signature pool using the at least first index of the first signature.

19. The non-transitory computer-readable storage medium of claim 18, wherein said at least first index of the first signature comprises the first index of the first signature and a second index of the first signature indicating the first signature pool in a plurality of first signature pools; and
wherein said obtaining the first signature from the first signature pool using the at least first index of the first signature comprises:
obtaining the first signature pool from the plurality of first signature pools using the second index of the first signature, and
obtaining the first signature from the first signature pool using the first index of the first signature pool.

20. The non-transitory computer-readable storage medium of claim 13, wherein the instructions, when executed, cause the processing structure to perform further actions comprising:
obtaining communication conditions of the physical resource; and
classifying a plurality of UEs using the physical resource for communication into one or more UE groups based on the obtained communication conditions, the plurality of UEs comprising the UE;
wherein said transmitting the wireless signal via the physical resource comprises:
transmitting the wireless signal to the UE via the physical resource; and
wherein said obtaining the first signature comprises:
determining the first signature based on the UE group of the UE.
